(19) United States
(12) Patent Application Publication
(10) Pub. No.: US 2026/0311046 A1
(43) Pub. Date: Oct. 8, 2026

(54) Systems And Methods For Automated Active Learning For Re-Training Of A Machine Learming Model

(71) Applicant: Cisco Technology, Inc., San Jose, CA (US)

(72) Inventors: Cui Lin, Los Altos, CA (US); Rodolfo J. Soto, Miramar, FL (US)

(21) Appl. No.: 19/213,820

(22) Filed: May 20, 2025

Related U.S. Application Data
(60) Provisional application No. 63/783,824, filed on Apr. 4, 2025.

(51) Int. Cl. G06N 20/00; G06F 11/34

(52) U.S. Cl. CPC G06N 20/00; G06F 11/3476

(57) ABSTRACT

Implementations of the disclosure provide a computerized method including operations of obtaining historical data including a plurality of data objects and performing, by a large language model (LLM), inferencing on the historical data resulting in generation of probabilistic labels including a probabilistic label for each of the plurality of data objects, wherein a first probabilistic label indicates whether a first data object is suspicious or benign. Further operations include determining a subset of the data objects with probabilistic labels having lowest confidence scores associated therewith and generating a graphical user interface (GUI) that displays the subset of the data objects. User input may be received indicating a label for each of the subset of the data objects, and when a percentage of the probabilistic labels that deviates from labels comprising the user input meets or exceeds a threshold percentage, initiating a re-training process on the LLM.

### CROSS-REFERENCE TO RELATED APPLICATIONS

This application claims the benefit of priority to U.S. Provisional Application No. 63/783,824, filed Apr. 4, 2025, which is incorporated by reference in its entirety into this application.

### FIELD

The present disclosure relates to artificial intelligence systems. More particularly, the present disclosure relates to automating active learning data labeling and machine learning (ML) model lifecycle management for pre-trained ML models.

### BACKGROUND

Large Language Models (LLMs) have progressed from early language-processing techniques to become sophisticated AI systems reshaping digital communication and content creation. The journey of LLMs started with basic natural language processing (NLP) research in the mid-20th century, but modern models emerged only recently, as advancements in deep learning and neural networks took center stage. The transformer architecture marked a turning point for LLMs, as it allowed models to capture complex dependencies and context in text efficiently. Since their inception, LLMs have pushed the boundaries of language understanding and generation. However, the success of these models also relies heavily on GPU capabilities, which enable the parallel processing required to handle the massive datasets and billions, or even trillions of parameters. GPUs can provide the speed and computational power that allow LLMs to perform real-time language tasks, even as they grow increasingly complex.

Industries are integrating LLMs in varied ways to streamline operations, boost creativity, and enhance productivity, with applications ranging from customer service to software development and healthcare. Advanced AI agents powered by LLMs are becoming common, allowing businesses to manage customer interactions through natural language understanding, where these agents can handle complex inquiries and generate detailed responses. In creative fields, LLM-based AI agents assist with drafting content, suggesting ideas, and even composing music or visual captions, enhancing creative processes by providing inspiration and augmenting human creativity. In software development, AI agents can automate parts of the coding process, generating code snippets, detecting bugs, and maintaining documentation. Healthcare is also benefiting from LLMs, as AI agents assist in summarizing medical records and offering preliminary diagnostic support. However, as LLMs and AI agents support these diverse applications, the demand on GPUs and network infrastructure grows considerably. To manage these increasing loads, organizations often rely on high-capacity Network Interface Cards (NICs) with load-balancing and flow control, such as Queue Pair (QP) capacity, to efficiently manage data flow and distribute tasks across clusters. This network infrastructure becomes essential for scaling up LLM-based agents to handle real-time interactions and large user bases without sacrificing responsiveness.

### BRIEF DESCRIPTION OF DRAWINGS

The above, and other, aspects, features, and advantages of several embodiments of the present disclosure will be more apparent from the following description as presented in conjunction with the following several FIGURES of the drawings.

FIG. 1 is a diagram depicting various subsets of artificial intelligence in accordance with various embodiments of the disclosure;

FIG. 2 depicts different methods of machine-based learning in accordance with various embodiments of the disclosure;

FIG. 3 depicts a machine learning lifecycle in accordance with various embodiments of the disclosure; and

FIG. 4 is an exemplary neural network for use in a fully controlled camera system in accordance with various embodiments of the disclosure.

FIG. 5 is a conceptual illustration of a variety of tokens for utilization within a large language model in accordance with various embodiments of the disclosure;

FIG. 6 is a conceptual illustration of an embedding matrix for a large language model, in accordance with various embodiments of the disclosure;

FIG. 7 is a conceptual illustration of an input prompt converted from a series of tokens into a series of tensors in accordance with various embodiments of the disclosure;

FIG. 8 is a conceptual illustration of an attention layer process within a large language model in accordance with various embodiments of the disclosure;

FIG. 9 is a conceptual illustration of a multi-layer perceptron within a large language model in accordance with various embodiments of the disclosure;

FIG. 10 is a conceptual illustration of an unembedding process within a large language model in accordance with various embodiments of the disclosure;

FIG. 11 is an architectural diagrammatic illustration of components forming an automated label generation, model retraining, and active learning system (“active learning system”) according to an implementation of the disclosure;

FIG. 12 is a diagrammatic illustration comprising a set of pipelines for automated label generation, model retraining, and an active learning process in accordance with various embodiments of the disclosure;

FIG. 13 is a flowchart illustrating example operations for performing operations illustrated in FIG. 12 of automated label generation, model retraining, and an active learning process in accordance with various embodiments of the disclosure;

FIG. 14 is a diagrammatic illustration of a first pipeline for automated label generation in accordance with various embodiments of the disclosure;

FIG. 15 is a flowchart illustrating example operations for performing operations illustrated in FIG. 14 of automated label generation in accordance with various embodiments of the disclosure;

FIG. 16 is a diagrammatic illustration of a second pipeline for model retraining in accordance with various embodiments of the disclosure;

FIG. 17 is a flowchart illustrating example operations for performing operations illustrated in FIG. 16 of model retraining in accordance with various embodiments of the disclosure;

FIG. 18 is a diagrammatic illustration of a third pipeline of an active learning process in accordance with various embodiments of the disclosure;

FIG. 19 is a flowchart illustrating example operations for performing operations illustrated in FIG. 18 of an active learning process in accordance with various embodiments of the disclosure;

FIG. 20 is a conceptual block diagram of a device suitable for configuration with an active learning system in accordance with various embodiments of the disclosure;

FIG. 21 is a flowchart illustrating example operations for performing an active learning process in accordance with various embodiments of the disclosure;

FIGS. 22A-22C illustrate an operational flow for performing a re-training of machine learning models by automatically generating labels for unlabeled, historical data through machine learning and active learning techniques in accordance with various embodiments of the disclosure; and

FIG. 23 is a flowchart illustrating example operations for performing a re-training of machine learning models by automatically generating labels for unlabeled, historical data through machine learning and active learning techniques in accordance with various embodiments of the disclosure.

Corresponding reference characters indicate corresponding components throughout the several FIGURES of the drawings. Elements in the several FIGURES are illustrated for simplicity and clarity and have not necessarily been drawn to scale. For example, the dimensions of some of the elements in the FIGURES might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

As those skilled in the art will recognize, Artificial Intelligence (AI) is a broad field within computer science focused on creating systems that can simulate aspects of human intelligence. These systems can range from simple rule-based programs to sophisticated models capable of learning, adapting, and making decisions based on data. AI spans various branches, including robotics, computer vision, natural language processing, and reinforcement learning, each aiming to enable machines to perform tasks that traditionally require human cognition. The potential of AI lies in its ability to enhance decision-making, improve efficiency, and even drive innovation across industries. With rapid advancements in computational power and algorithm design, AI is becoming increasingly embedded in our daily lives, powering applications from personal assistants to autonomous vehicles and even aiding in scientific research and complex problem-solving.

Machine learning (ML) is a crucial subset of AI that involves systems learning from data to make predictions or decisions without being explicitly programmed for each task. Unlike traditional software, which relies on hard-coded rules, machine learning systems use algorithms that identify patterns and adjust their behavior based on experience. ML includes various techniques, such as supervised learning, unsupervised learning, and reinforcement learning, each suited to different kinds of tasks. For example, supervised learning is commonly used in classification tasks, while reinforcement learning drives decision-making in dynamic environments. ML serves as the foundation for many modern AI applications, as it enables systems to generalize from data and improve over time. As such, ML systems are central to the development of more advanced AI models and applications, including those that require nuanced understanding, like image recognition and language processing.

Large Language Models (LLMs) represent a specific application of machine learning within AI, focused on understanding and generating human language. Positioned within the broader field of natural language processing (NLP), LLMs utilize advanced machine learning architectures, particularly deep learning and transformer models, to process vast amounts of text data. Through this training, LLMs develop the ability to capture context, generate coherent responses, and perform complex language-based tasks, making them valuable tools in a range of applications, from chatbots to content creation and data analysis.

By processing vast amounts of text data, these LLMs can capture intricate patterns, nuances, and contextual relationships within language, allowing them to respond with relevance and a degree of fluency previously seen only in human communication. Broadly, LLMs work by breaking down text into tokens, converting them into vector representations, and using complex architectures with attention layers and multi-layer perceptrons to generate contextually appropriate responses. This process can enable the models to understand context, recall relevant information, and even produce creative or technical outputs based on learned knowledge. Their impact spans multiple industries. For example, they can support customer service, automate repetitive tasks, assist with brainstorming and writing, and even provide foundational support in software development and data analysis.

As those skilled in the art will recognize, the principles underlying LLMs can be generalized to other forms of AI models that handle diverse types of data, such as audio, visual, and even multimodal information. While LLMs are specialized for processing and generating language, similar architectures and concepts apply to Large Audio Models (LAMs), Large Vision Models (LVMs), and Large Foundation Models (LFMs) that incorporate multiple data types. These models operate on the same foundational ideas such as breaking down complex input (whether sounds, images, or mixed formats) into smaller, structured units, transforming these into numerical representations, and using layers of processing to capture relationships, context, and patterns within the data. Just as LLMs use tokens and embeddings for text, LAMs may segment and analyze audio signals, while LVMs and LFMs might extract features from images or combine textual and visual data for a richer, holistic understanding. This generalizable framework can enable AI to address tasks across different domains, making it possible to train models that understand, generate, and respond to varied data formats, whether in speech recognition, image analysis, or other complex, cross-functional applications. Consequently, the discussion of LLMs opens doors to understanding a broader landscape of AI technologies that share structural similarities yet target distinct types of information.

In many embodiments, the first stage in processing with an LLM can involve breaking down text into tokens, which are individual units that may represent words, subwords, or characters. This process, called tokenization, can assign each unique token a specific identifier, providing a standard format that the model can use to handle text more systematically. By transforming language input into a structured sequence of tokens, the model can gain a foundation that supports further transformations and simplifies working with complex text.

In more embodiments, the model may use an embedding matrix to convert each token into a dense vector, capturing its semantic meaning in numerical terms. The embedding matrix may hold a unique vector representation for each token, designed so that similar words or concepts can be positioned near each other in the model's multi-dimensional space. This approach can help the model achieve a form of conceptual understanding, where tokens with related meanings may be encoded in ways that reflect their relationships. By producing these vector representations, the model can start to develop a nuanced understanding of each token's role within a broader context.

With tokens now represented as vectors, the model can organize these vectors into an array that may hold the sequence of tokens from the original input text. This array can preserve the order of tokens, structuring them as a unified dataset for further processing. By arranging token information in this structured format, the model can prepare the data for a sequence of processing layers that may work to extract patterns and relationships within the data. Each vector within the array can carry information about a token's meaning and context, positioning the data for deeper levels of processing.

In further embodiments, an LLM can include one or more attention layers, which can enable the model to compare different parts of the input sequence and assess their contextual relevance. These attention layers may allow the model to assign varying levels of focus across tokens depending on the patterns it detects, highlighting words or phrases that can carry the most significance in a given context. By adjusting its focus across the sequence, the model can capture relationships between tokens that may not be apparent from isolated words. The attention mechanism can help the model build a detailed understanding, determining which parts of the input should influence the output most strongly.

Once these attention layers have established relationships within the input, the data may pass through one or more Multi-Layer Perceptrons (MLPs). In further embodiments, MLPs are fully connected neural networks that can refine the data further by identifying additional complex relationships and patterns. This stage may allow the model to distill its understanding of the input text, building on insights from the attention layers to develop an even more structured form of comprehension. The MLPs can support the model's ability to respond with greater relevance and coherence by transforming these contextual insights into a format ready for output.

Finally, in various embodiments, the refined data may reach an unembedding layer, where the model can translate its internal vector representations back into tokens. At this stage, the model can select the most probable next token based on the processed data, starting to generate a coherent output sequence. This transformation can allow the model to return from its internal numerical understanding to human-readable language, producing tokens that form a meaningful response. By iterating through these steps, the model can generate an output sequence that aligns with the context of the input, completing the journey from initial text input to comprehensible, contextually relevant output.

Aspects of the present disclosure may be embodied as an apparatus, system, method, computer-implemented method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the FIGURES. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated FIGURES. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding FIGURES. Like numbers may refer to like elements in the FIGURES, including alternate embodiments of like elements.

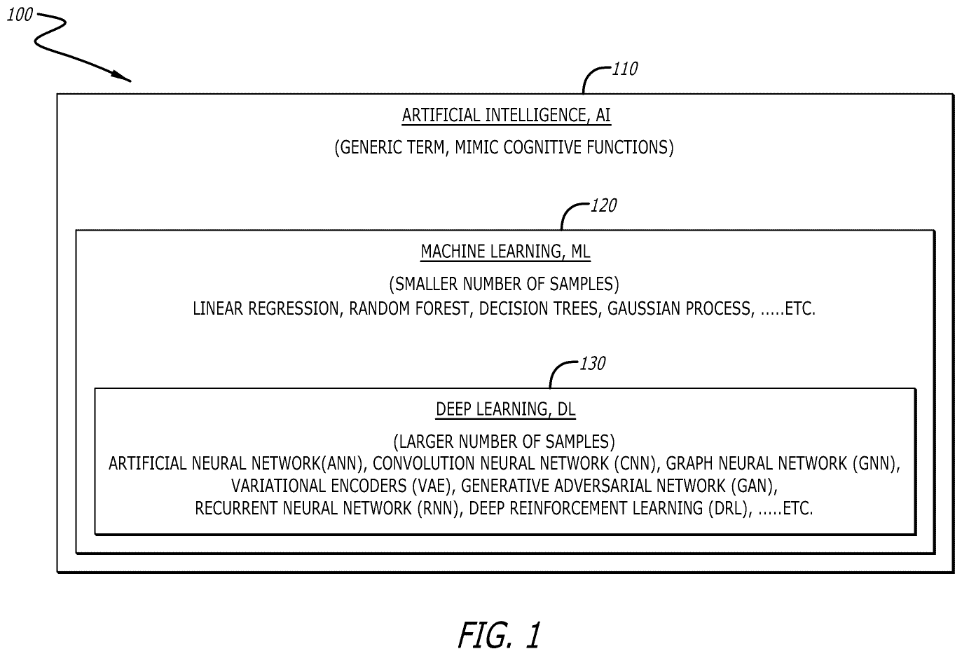

Referring to FIG. 1, a diagram 100 depicting various subsets of artificial intelligence in accordance with various embodiments of the disclosure is shown. Artificial intelligence (AI) 110 is typically understood in the art to be the development of machines and algorithms that mimic human intelligence, for example, by optimizing actions to achieve certain goals. At its core, AI 110 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 110 can be considered a generic term because it encompasses a wide range of subfields and techniques, from simple rule-based systems to advanced machine learning and deep learning models. These AI techniques are used to simulate various aspects of human cognition. For example, machine learning (ML) 120 allows computers to learn from data patterns without explicit programming for each task, while natural language processing (NLP) enables machines to understand and generate human language. Deep learning (DL) 130, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 110 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML) 120 is a subset of Artificial Intelligence (AI) 110 that focuses on the development of algorithms and statistical models that enable computers to learn and make decisions from data without explicit programming. In traditional programming, a computer is given a fixed set of rules to follow, but ML 120 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 120. These algorithms can handle various data types, including numerical, categorical, and structured datasets like spreadsheets or grids. One of the key strengths of ML is its ability to generalize from the training data to make accurate predictions on new, unseen data.

However, traditional ML methods rely heavily on feature engineering, wherein human experts manually identify the most relevant features or patterns within the data. For example, when using ML 120 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 100) to learn effectively.

Deep Learning (DL) 130 is a specialized subset of Machine Learning (ML) 120 that employs multi-layered artificial neural networks to automatically learn complex patterns and representations from large, often unstructured datasets. Inspired by the way the human brain processes information, DL 130 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 130 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini batches can be utilized to prevent the network from becoming overly specialized to the training set.

CNNs are a specific type of ML 130 neural network designed to work particularly well with image data, making them highly relevant for image and video data processing. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction that is relevant to the underlying process being executed.

While CNNs are well-suited for grid-based data like images, many real-world problems can involve non-grid data. This type of data may better be represented as a graph, where nodes represent entities (e.g., specific items) and edges represent relationships between them (e.g., characteristics, values, etc.). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is crucial in predicting properties that depend on the current/local structure, such as the behavior of an entity or the properties of a related to that or associated entities.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This can allow for the generation of new data by sampling points from the latent space. Similarly, GANs often consist of two components: a generator that creates fake/generated data and a discriminator that tries to distinguish between real and fake data. The two components can be trained in a competitive process where the generator tries to “fool” the discriminator, leading to increasingly realistic generated data.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex data simulations. In various embodiments, DRL can be used in scenarios where an optimal decision needs to be made. The combination of RL and DL can allow for learning from raw data, making it a powerful tool for dynamic and real-time decision-making within various embodiments.

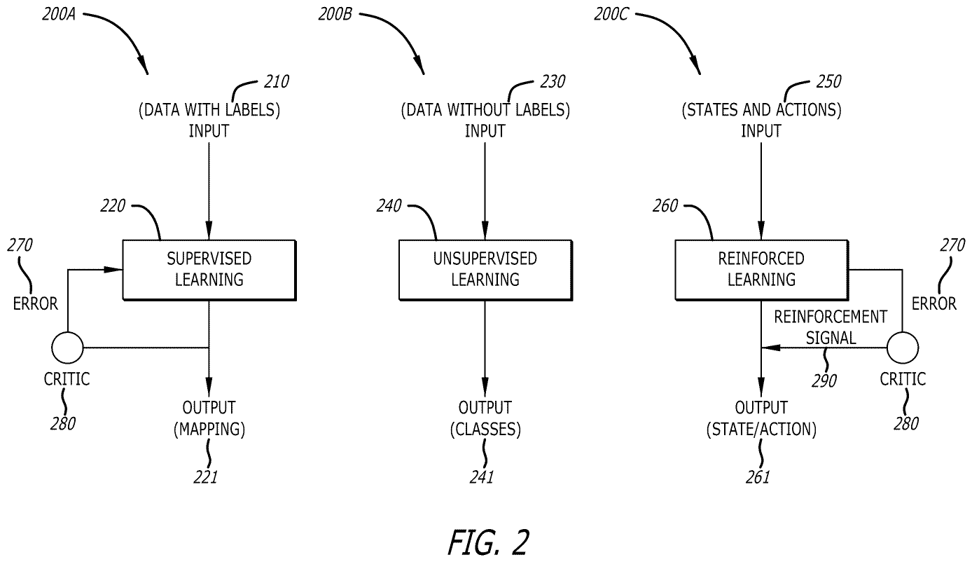

Although a specific embodiment for a diagram 100 depicting various subsets of artificial intelligence suitable for carrying out the various steps, processes, methods, and operations described herein is discussed with respect to FIG. 1, any of a variety of systems and/or processes may be utilized in accordance with embodiments of the disclosure. For example, other subset may be present and available for use within AI 110. Those skilled in the art will recognize that the diagram 100 presented in FIG. 1 is simplified for illustration purposes and various methods and techniques may interact with other areas (ML 120 with DL 130, etc.). The elements depicted in FIG. 1 may also be interchangeable with other elements of FIGS. 2-10 as required to realize a particularly desired embodiment.

Referring to FIG. 2, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 2, a supervised learning system 200A is shown. The supervised learning system 200A can be configured with a supervised learning model 220 that accepts input data 210 and generates an output 221. However, the output data is often reviewed by a critic 280 that can determine one or more errors 270 that are fed back into the supervised learning model 220 for use in updating.

Supervised learning systems 200A are often considered the simplest machine learning model to understand in which input data (such as training data) has a known label or result as an output. So, the supervised learning model 220 can be understood to work on the principle of input-output pairs. As such, a function can be trained using a training data set, which is then applied to unknown data and makes some predictive performance. Supervised learning is task-based and mostly tested on labeled data sets.

Supervised learning systems 200A may often involve one or more regression problems. In regression problems, the output is a continuous variable. Some commonly used Regression models include linear regression, decision trees, and random forests. Linear regression is typically the most straightforward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. The advantage of decision trees is that they are intuitive and easy to implement, but may lack accuracy depending on the available computational or time resources.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a certain routing pathway is optimal or not, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features.

Again, in the embodiment depicted in FIG. 2, an unsupervised learning system 200B is shown. The unsupervised learning system 200B can be configured with an unsupervised learning model 240 that accepts input data 230 and generates an output 241. Unlike other model types, there are no critics or error signals to process. Unsupervised learning models 240 can implement the learning process opposite to supervised learning, which means it enables the model to learn from an unlabeled training dataset. Based on the unlabeled dataset, the unsupervised learning model 240 can predict the output. Using an unsupervised learning system 200B, the unsupervised learning model 240 can learn hidden patterns from the dataset by itself without any supervision. In various embodiments, unsupervised learning models 240 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 2, a reinforcement learning system 200C is shown. The reinforcement learning system 200C can be configured with a reinforcement learning model 260 that accepts input data 250 and generates an output 261. In reinforcement learning, the reinforcement learning model 260 learns actions for a given set of states that lead to a goal state. In the embodiment depicted in FIG. 2, a critic 280 can receive or otherwise notice an error 270 within the reinforcement learning model 260 actions, and adjust the outcome/output such that the “reward” or “punishment” is adjusted to better model the future behaviors or processing of the reinforcement learning model 260.

It is a feedback-based learning model that can take feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning include q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DON) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 2, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 2 may also be interchangeable with other elements of FIGS. 1 and 3-10 as required to realize a particularly desired embodiment.

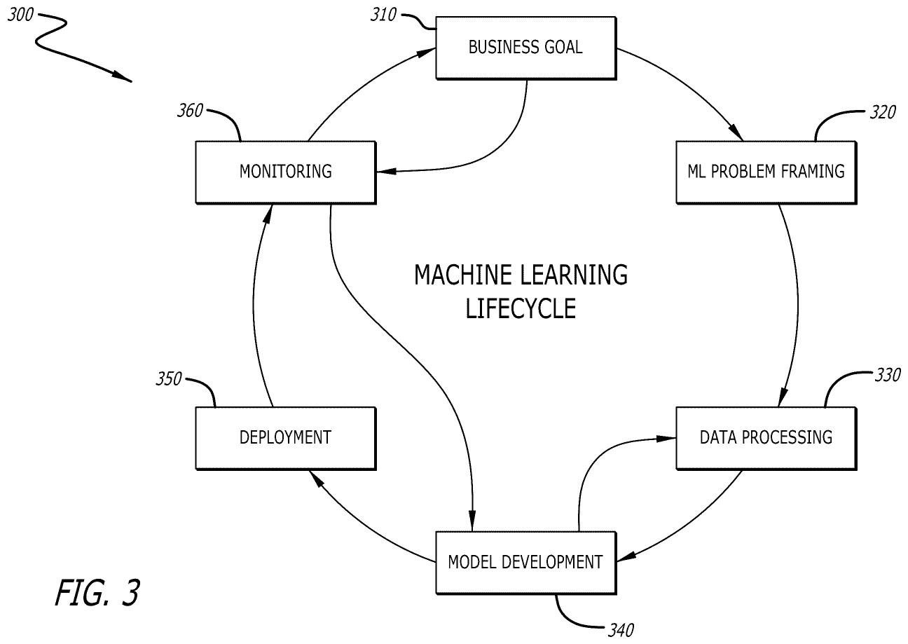

Referring to FIG. 3, a machine learning lifecycle 300 in accordance with various embodiments of the disclosure is shown. During the development of machine learning systems, the embodiment depicted in FIG. 3 can provide a framework for how to structure the design and maintenance of these systems. This machine learning lifecycle 300 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 300 emphasizes that developing a machine learning model is not a one-time effort but an iterative process requiring ongoing monitoring and adjustment. The feedback loop inherent in the machine learning lifecycle 300 allows for continual refinement and optimization of models to maintain their accuracy and relevance.

In many embodiments, a first stage of the machine learning lifecycle 300 is identifying the business goal 310, which sets the overall direction and purpose of the ML project. This can involve understanding the specific problems or opportunities within the business or project that machine learning can address. A clear business goal 310 ensures that the project remains focused on delivering tangible value. Without a well-defined goal, it can be challenging to align the subsequent stages of the ML lifecycle 300, as the choice of model, data processing methods, and performance metrics can all depend on what the business aims to achieve.

Establishing a proper business goal 310 can also involve engaging with key stakeholders and developers to gather requirements and set success criteria. It can provide a roadmap that outlines what success looks like and helps in framing the ML problem. Clearly defined goals not only help guide the project but also provide benchmarks for evaluating the effectiveness of the deployed model once it enters production.

Once the business goal 310 is established, various embodiments take a next step involving ML problem framing 320, wherein the goal is translated into a specific machine learning task. This can involve selecting the appropriate type of ML problem, such as classification, regression, clustering, or recommendation, and defining the target variables or outputs. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 330 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 330 can require or at least benefit from careful planning and iterative refinement. Once the data is processed, it is typically split into training, validation, and test sets to develop and evaluate the model, ensuring that it generalizes well to new, unseen data.

Model development 340 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 340, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 330.

In further embodiments, deployment 350 is the stage where the developed model is integrated into the production environment to perform its intended tasks. This phase may involve setting up the necessary infrastructure, such as APIs or cloud-based services, to allow the model(s) to process live data and generate predictions. Deployment 350 can transform the model from a research tool into a functional component of a business process or product, providing real-time insights, automations, or decisions.

Proper deployment 350 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 310.

In more embodiments, monitoring 360 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 360, teams can identify when the model's performance drops and requires retraining or adjustments to align with the evolving data.

Monitoring 360 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 330 and model development 340, to refine the model(s) as needed. This iterative process allows the machine learning system to adapt and maintain its alignment with the original business goal 310 over time.

Although a specific embodiment for a machine learning lifecycle 300 suitable for carrying out the various steps, processes, methods, and operations described herein is discussed with respect to FIG. 3, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 3 may also be interchangeable with other elements of FIGS. 1-2 and 4-10 as required to realize a particularly desired embodiment.

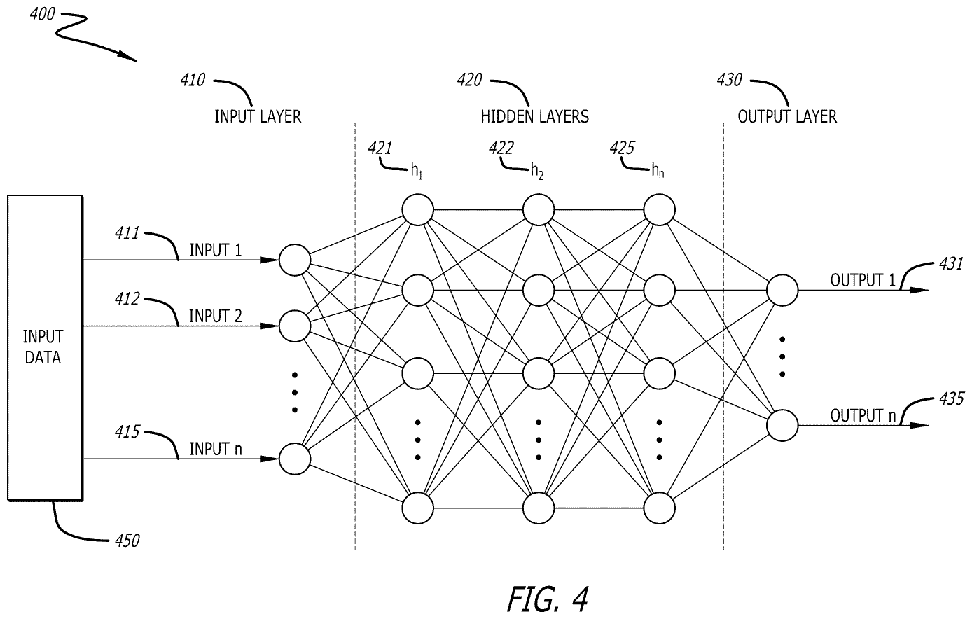

Referring to FIG. 4, an exemplary neural network 400 in accordance with various embodiments of the disclosure is shown. The embodiment depicted specifically depicts a feedforward neural network with multiple layers. This type of network consists of an input layer 410, one or more hidden layers 420, and an output layer 430. Each layer contains nodes (or neurons) that are interconnected, representing how data flows through the network. The input layer 410 can receive raw data, which is then processed by the hidden layers 420 through weighted connections and activation functions. These hidden layers 420 can enable the network to learn complex patterns and relationships within the data.

The final output layer 430 produces the network's predictions or classifications based on the processed input. The interconnected nature of the nodes allows the neural network 400 to learn from data during training by adjusting the weights of connections to minimize prediction errors. This structure is the foundation of deep learning models, as adding more hidden layers 420 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 400 depicted in the embodiment of FIG. 4, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 4 is presented as an exemplary ML solution that may be deployed within one or more methods or systems described herein.

In many embodiments, the input layer 410 is the first layer in a neural network 400 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 400 are generally scaled i.e., normalized to have a zero mean and/or unit standard deviation. Scaling can also be applied to the input of hidden layers (using batch or layer normalization) to improve the stability of neural network 400.

Unlike the hidden layers 420 and output layers 430, the input layer 410 typically does not perform any computations or transformations on the data. Its primary function is often to pass the input data to the next layer in the network, the first hidden layer 421. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 410 itself does not modify the data, it sets the stage for the neural network to extract complex patterns and relationships through the deeper layers. This flexibility in handling various types of input make the neural network 400 a powerful tool for a diverse set of applications.

With respect to the embodiments described herein, the input layer may be configured with a plurality of inputs providing input data 450. As those skilled in the art will recognize, input data 450 can vary in form, structure, or size based on the specific application desired. For example, in large language models, the input may be one or more tokens taken from an input provided by a user. The neural network 400 may also be a more specific step or sub-step within a larger AI/ML system. In some embodiments, the neural network 400 may be a part of a multi-layer perceptron within a large language model. However, as those skilled in the art will recognize, additional setups can be configured to format the input data 450 in a satisfactory way prior to processing by the neural network 400.

In a number of embodiments, the neural network 400 may comprise a plurality of hidden layers 420. The embodiment depicted in FIG. 4 comprises a first hidden layer 421, a second hidden layer 422, and an nth hidden layer 425, which are denoted as h₁, h₂, and hₙ respectively. In many embodiments, the hidden layers 420 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 421 h₁ receives direct input from the input layer, transforming the raw data into an initial set of features. For example, in an image recognition task, this layer might begin identifying basic patterns, such as edges or simple textures. The output of the first hidden layer 421 is then passed to a second hidden layer 422 h₂, which builds upon the features identified by the first hidden layer 421. This deeper layer might start recognizing more complex patterns, such as shapes or specific object components, by combining the lower-level features identified earlier. This can continue on until a last, nth hidden layer 425 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first input layer 421 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 430 is often the final layer in a neural network and is responsible for producing the network's predictions or classifications based on the information processed through the previous hidden layers 420. Each neuron in the output layer 430 can represent a specific outcome or category that the model can predict. In the embodiment depicted in FIG. 4, the outputs are labeled as “output 1” to “output n,” indicating that the network can be designed to have a varying number of outputs depending on the nature of the problem being solved for. For example, in a binary classification task (e.g., an email is spam vs. an email is safe), there would typically be a single output neuron that provides a probability score for one of the two classes/outcomes. In contrast, for multi-class classification (e.g., determining an optimal path from many to transmit data), the output layer would contain multiple neurons, each corresponding to a different class.

The number of neurons in the output layer 430 can be designed specifically for other types of tasks, such as regression, where the model can predict continuous values. In such cases, the output layer 430 might contain a single neuron representing a numerical prediction, such as the price of a house or the temperature forecast, etc. Alternatively, in complex applications like multi-label classification (where each input can belong to multiple classes simultaneously), the output layer 430 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a SoftMax function can be applied to output a set of probabilities that sum to 1, indicating the most likely class. For regression problems, a linear activation function is often used to output a continuous range of values. The flexibility in designing the output layer allows the neural network 400 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 4, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 4, which is an illustrative example meant to make it easier to explain the basic concepts of neural networks and how they process information. The specific features and functions described herein are not intended to be limiting to this specific embodiment. Additionally, the elements depicted in FIG. 4 may also be interchangeable with other elements of FIGS. 1-3 and 5-10 as required to realize a particularly desired embodiment.

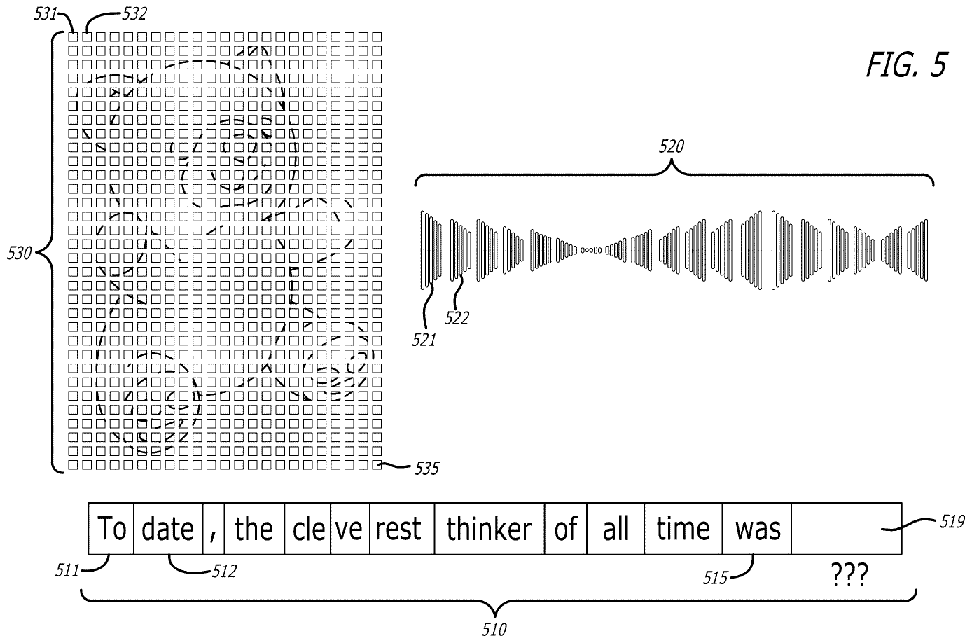

Referring to FIG. 5, a conceptual illustration of a variety of tokens for utilization within a large language model in accordance with various embodiments of the disclosure is shown. While most people are familiar with typing commands directly into a computer, interacting with a large language model (LLM) typically involves using prompts that are broken down into smaller units called tokens. These tokens can be segments of the original input prompt, such as individual words, subwords, or characters, allowing the model to process the prompt in manageable, structured pieces for a more nuanced understanding.

In fact, tokens are most often a fundamental unit of data used to represent a larger, general input for large language models (LLMs) and similar AI systems. In the context of LLMs, tokens are segments of text derived from the input prompt, where each token represents a manageable piece of the input, such as a word, part of a word, or a character. This segmentation can allow the model to break down complex text into simpler, consistent units that can be processed independently and then understood in relation to each other. By dividing input data into tokens, LLMs can handle language in a structured, flexible manner, adapting to diverse text inputs, from full sentences to specialized jargon or short phrases.

In many embodiments, tokens can serve as building blocks, enabling models to interpret language by analyzing these discrete parts and their relationships. For instance, in English, tokens often correspond to whole words, but when dealing with specialized vocabulary, slang, or languages with compound words, tokens might represent subwords or even single characters. This tokenization approach helps to maintain a balance between flexibility and precision, as smaller tokens allow the model to handle unfamiliar or highly specific terms more effectively. In a number of embodiments, each token can be encoded with a unique identifier that the model can use to differentiate it from others, preserving the distinct meaning or function it carries in context.

In the embodiment depicted in FIG. 5, a textual input prompt 510 is shown as divided up into a plurality of tokens. A first token 511 includes the word “To” while a second token comprises the next word “date”. In some embodiments, the first token 511 can be configured to include the space between “To” and “date”. This small change can be utilized by the LLM to further divine meaning from the textual input prompt 510. The number of tokens can vary depending on the type of input provided. This can extend from the first token 511 to the nth or last token 515 within the textual input prompt 510. This last token 519 can be utilized to indicate a requested or projected response 519.

Beyond text, similar tokenization principles may apply to other data types when used in models that process audio or visual input. For audio data, tokenization can involve dividing a sound file into slices, where each token might represent a short segment of audio, perhaps a fraction of a second or a small, meaningful slice of a larger waveform. By breaking audio down in this way, the model can analyze specific sounds, pitches, or rhythms within the context of the entire recording. This segmentation enables the model to interpret audio inputs in a structured format, similar to how language is tokenized, making it easier to process complex auditory patterns and understand sounds in a sequential manner.

In the embodiment depicted in FIG. 5, the audio input prompt 520 is shown divided into a plurality of audio slices. The first audio token 521 comprises a number of samples within the audio input prompt 520. Likewise, the second audio token 522 comprises a second number of samples within the audio input prompt 520. This slicing of the audio input prompt 520 can continue throughout the rest of the remaining audio such that when all tokens have been processed, the system can determine a best guess for the next audio token that should be appended to the end of the audio input prompt 520.

In the case of visual data, such as images, tokenization often involves segmenting the image into smaller chunks or patches, each of which becomes a visual token. These tokens represent different parts of the image, like color regions, edges, or textures, which the model can examine individually. Visual tokens enable the model to capture the intricate details within an image by focusing on manageable portions, while still considering their relationships to the broader visual structure. This approach allows AI systems to interpret complex images by analyzing these visual segments in the same way LLMs handle text tokens, offering a structured method for processing and understanding visual content.

In the embodiment depicted in FIG. 5, the image data prompt 530 is divided into a plurality of smaller visual tokens. The first visual input token 531 is shown as a small square portion of the original, larger image. This procedure of processing various chunks of the original image data prompt 530 can occur on these smaller portions of the image, such as the second visual input token 531, up to and including the nth visual input token 539. Each of these smaller visual tokens can be processed individually, but often in parallel to each other.

The concept of tokens is therefore versatile, allowing diverse types of input, whether text, sound, or images, to be converted into standardized, model-friendly formats. Tokenization creates a consistent framework for representing complex data types in a way that artificial intelligence systems can process effectively. This segmentation enables each model, regardless of the input type, to dissect and examine different parts of the data with a fine level of granularity, which is especially important when working with highly detailed or nuanced inputs. This tokenized structure can enable the model to interpret the input systematically, providing a foundation for further processing and understanding of the information encapsulated within each token.

Although a specific embodiment for a variety of tokens for utilization within a large language model suitable for carrying out the various steps, processes, methods, and operations described herein is discussed with respect to FIG. 5, any of a variety of systems and/or processes may be utilized in accordance with embodiments of the disclosure. In many non-limiting examples, the type and number of tokens can vary depending on the specific application desired and/or the amount of available processing power available to handle the input prompt. The elements depicted in FIG. 5 may also be interchangeable with other elements of FIGS. 1-4 and 6-9 as required to realize a particularly desired embodiment.

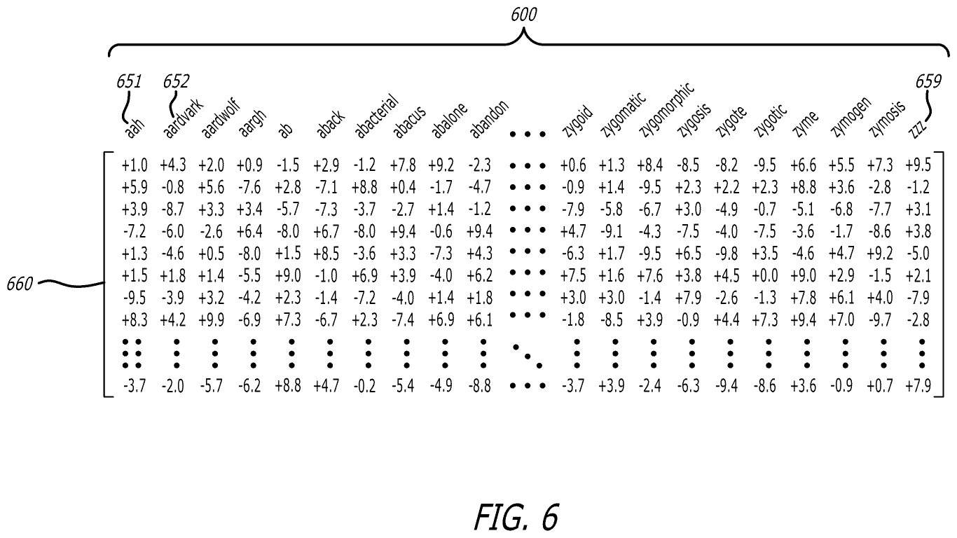

Referring to FIG. 6, a conceptual illustration of an embedding matrix 600 for a large language model, in accordance with various embodiments of the disclosure is shown. In many embodiments of large language models (LLMs), embedding matrices are components that enable the model to interpret tokens in a mathematically accessible way. An embedding matrix 600 is essentially a large table of vector representations, where each token in the model's vocabulary is assigned a unique vector, or array of numbers, that captures its initial meaning in relation to other tokens. When an input prompt is tokenized, each token can be matched with a corresponding entry in the embedding matrix 600. In a number of embodiments, this lookup process can provide the token with an initial value, or embedding, which represents the token in a multi-dimensional space. These embeddings allow the model to recognize patterns, relationships, and meanings in language beyond simple string matching, forming the foundation for all further processing within the model.

In a number of embodiments, each entry in the embedding matrix 600 is a vector of fixed size, with each dimension in the vector representing a distinct feature or aspect of the token's meaning. For example, words that are semantically or contextually similar may have embeddings that place them close to one another in this multi-dimensional space. This spatial relationship allows the model to capture a form of conceptual proximity wherein synonyms or related terms might occupy nearby areas in this space, while antonyms or unrelated words are farther apart. By assigning each token an embedding with specific values, the matrix can encode subtle linguistic and contextual information into numerical form, enabling the model to work with tokens in a highly structured, yet flexible, manner.

In the embodiment depicted in FIG. 6, the embedding matrix 600 is associated with every known word in the English language. In other words, the matrix has a column associated with each of the around 50,000 or so words in English. Each column of the embedding matrix 600 comprises a vector 660 which associates the corresponding word to a location with a multi-dimensional space. For example, the first word 651 “aah” has a corresponding vector 660 from the first entry +1.0, to the nth entry −3.7. Likewise, the second word 652 “aardvark” has another column of vector values associated with it starting at +4.3 and ending in −2.0. Finally, the nth word 659 “zzz” is associated with a corresponding vector 660 that includes the values in the column starting at +9.5 to +7.9. As each token is processed, it is assigned the corresponding vector 660 taken from the embedding matrix 600.

The embedding matrix 600 is typically learned during the model's training phase. As the model is exposed to vast amounts of text, it iteratively adjusts the values in the embedding vectors to capture the relationships between tokens more accurately. Through this process, embeddings evolve to represent the associations, contexts, and distinctions that the model has observed across its training data. For instance, words that frequently appear together or in similar contexts may have embeddings that reflect this association. The embedding matrix 600 thus serves as a kind of “knowledge base” for initial token relationships, giving the model a structured way to approach the vast variability in language.

This embedding approach is highly efficient because it enables the model to generalize across contexts and recognize similarities even with previously unseen tokens. For example, even if a token or phrase in a prompt has not been encountered during training, the model can infer its meaning based on the embeddings of other, similar tokens. This generalization is possible because embeddings capture both specific meanings and broader patterns, allowing the model to interpret novel inputs based on its learned understanding of language structure and relationships. By embedding tokens in a shared space, the model can gain a foundational understanding of language that it can apply across various prompts and contexts. This arrangement can allow the LLM to move beyond a rigid, word-by-word interpretation and instead engage with language as a rich network of interconnected meanings and ideas.

Although a specific embodiment for an embedding matrix for a large language model suitable for carrying out the various steps, processes, methods, and operations described herein is discussed with respect to FIG. 6, any of a variety of systems and/or processes may be utilized in accordance with embodiments of the disclosure. For example, similar concepts associated with the embedding matrix 600 of FIG. 6 can be applied to other types of embedded matrices associated with other data types. It is contemplated that the embedding matrix is only limited by the types of input data that it is configured to process. The elements depicted in FIG. 6 may also be interchangeable with other elements of FIGS. 1-5 and FIGS. 7-9 as required to realize a particularly desired embodiment.

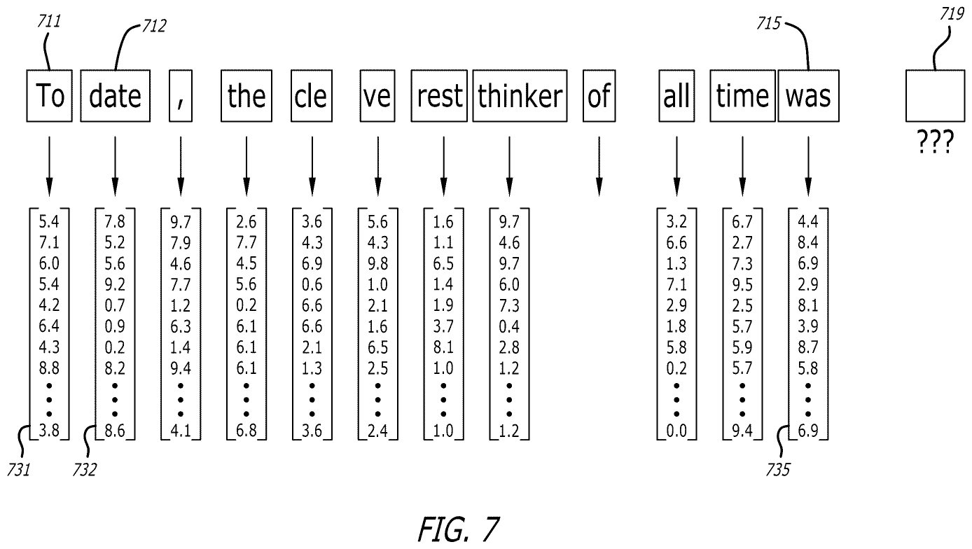

Referring to FIG. 7, a conceptual illustration of an input prompt converted from a series of tokens into a series of tensors in accordance with various embodiments of the disclosure is shown. In many embodiments, when an input prompt is converted into tokens, each of these tokens is then transformed through an embedding matrix to yield a unique vector representation, known as an embedding. This embedding is often a numerical array, or tensor, that encodes the token's position, context, and meaning within a multi-dimensional space. Essentially, once the tokenized prompt passes through the embedding matrix, each token is matched with a tensor that captures both its individual characteristics and its relationships to other tokens in the model's vocabulary. These tensors form the foundational representation of the prompt, providing structured data that the model can process to understand and generate contextually relevant responses.

Each tensor associated with a token after embedding can represent a fixed number of dimensions, often hundreds or even thousands, depending on the model's architecture. These dimensions give the tensor a rich structure, with each element in the tensor reflecting different features of the token's meaning. For instance, certain dimensions might encode aspects related to semantic similarity, part of speech, or contextual nuances observed during training. By encoding these complex features into a tensor, the model gains a detailed, flexible understanding of the token's role in the input prompt, which becomes critical for capturing context, sentiment, and intent in language processing tasks.

In various embodiments, the collection of tensors generated from the embedded tokens can create a high-dimensional representation of the entire prompt, with each tensor holding a unique set of values corresponding to its specific token. Because each tensor encodes information about a single token, the model can recognize patterns in the prompt by examining the relationships between these tensors. For example, words that often appear together may have similar values in certain dimensions of their tensors, allowing the model to capture implicit relationships and context within the input. This organized structure of tensors provides the model with a map of the prompt that it can analyze to make inferences about meaning, order, and emphasis.

In the embodiment depicted in FIG. 7, the first token 711 is associated with the word “To” and has a corresponding tensor 731 which is an array in multi-dimensional space. Likewise, the second token 712 is associated with a second tensor 732. Each token within the input prompt is subsequently associated with a corresponding tensor, up to the last and nth token 715 which is associated with the nth tensor 735. Processing these input prompt tokens will yield a projected or otherwise best fit for what the next token/word 719 will be.

In further embodiments, the use of tensors can allow the model to handle complex language structures efficiently, as each token's tensor can interact with others in ways that reflect natural language dependencies. By representing each token as a tensor, the model can apply various mathematical operations across these tensors to analyze and synthesize information. These operations enable the model to determine which tokens are most relevant to one another within the context of the prompt. For instance, determining the vector difference between two related words like “man” and “woman” may be applied to a different context to determine similar words like applying that same vector difference to the vector associated with “uncle” to lead to the vector associated with the word “aunt”.

Although a specific embodiment for an input prompt converted from a series of tokens into a series of tensors suitable for carrying out the various steps, processes, methods, and operations described herein is discussed with respect to FIG. 7, any of a variety of systems and/or processes may be utilized in accordance with embodiments of the disclosure. For example, the number of elements within a tensor can number in the thousands, or even tens of thousands, depending on the complexity of the model. Additionally, in various embodiments, the position of the token within the input prompt can also be encoded within the tensor, which may be done by processing some additional value to the original tensor. The elements depicted in FIG. 7 may also be interchangeable with other elements of FIGS. 1-6 and FIGS. 8-10 as required to realize a particularly desired embodiment.

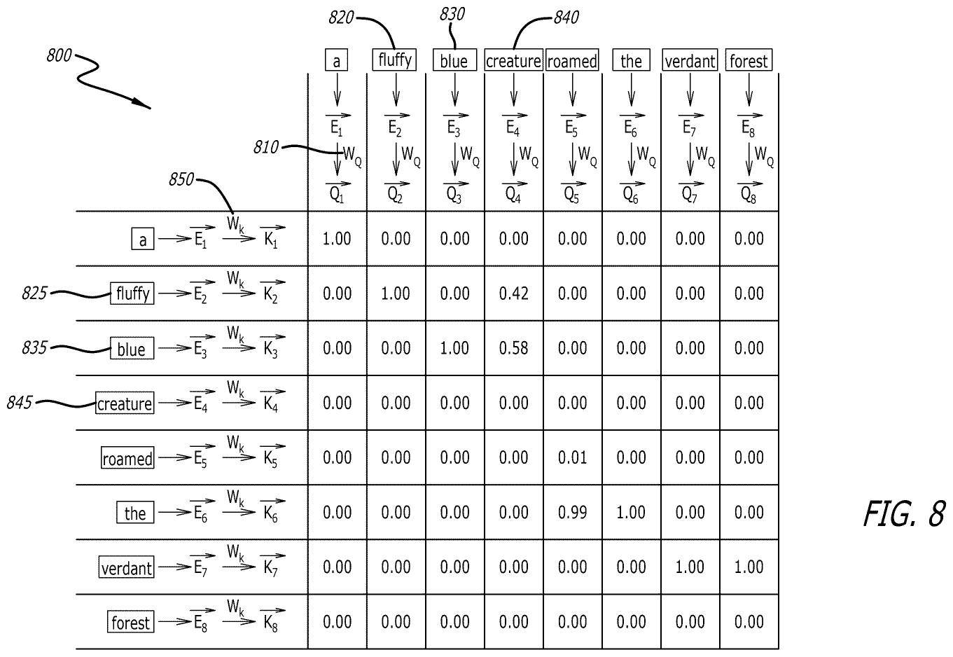

Referring to FIG. 8, a conceptual illustration of an attention layer process 800 within a large language model in accordance with various embodiments of the disclosure is shown. When processing languages such as English, understanding the context of each word or token within an input prompt is beneficial. As such, many embodiments herein comprise at least one attention layer for processing the embedded tokens.

Take for example, the following three sentences: “I saw an American shrew mole,” “Measure one mole of carbon dioxide,” and “Take a biopsy of that mole”. Each of these sentences utilize the word “mole” in distinct contexts, demonstrating how language can carry multiple meanings based on surrounding words and phrases. In natural language processing, understanding these varied meanings requires the model to consider each token in relation to its neighbors, which is where attention layers become crucial. By focusing on the surrounding context of each instance of “mole,” an attention layer can discern whether it refers to an animal, a unit of chemical measurement, or a skin lesion. In many embodiments, the context, or set of nearby tokens, can allow the model to assign different meanings to “mole” depending on which other words are present, such as “American shrew” in the first case, “carbon dioxide” in the second, and “biopsy” in the third.

In a number of embodiments, attention layers can enable the model to weigh the relevance of each neighboring token to identify the specific meaning of “mole” in each phrase. For example, in “An American shrew mole,” the attention mechanism can emphasize the tokens “American” and “shrew,” which typically appear in contexts related to animals, thus guiding the model to interpret “mole” as a small mammal. Conversely, for the phrase “One mole of carbon dioxide,” however, the presence of “carbon dioxide” and the numerical term “one” shifts the focus toward scientific terminology, signaling that “mole” refers to a unit of chemical measurement. Similarly, in “Take a biopsy of that mole,” attention is drawn to the medical term “biopsy,” leading the model to interpret “mole” as a skin lesion. Through this mechanism, attention layers allow the model to dynamically adapt its understanding of words based on context, handling polysemous terms (words with multiple meanings) with greater accuracy.

In this way, attention layers can help the model “tease out” the correct meanings by selectively focusing on relevant tokens within the prompt. By assigning higher weights to contextually significant words, the model can make nuanced distinctions between different senses of the same token. This ability to disambiguate words based on context is essential for LLMs to generate accurate and meaningful responses, as it enables them to navigate the inherent complexity and flexibility of human language.

In literature, the generation of “attention” with these attention layers is described as:

$$Attention ( Q , K , V ) = softmax ( \frac{{QK}^{T}}{\sqrt{{d}_{k}}} ) V$$

Wherein Q represents the query matrix which itself is a placeholder for the “query” vectors derived from each embedded token in the input sequence. When processing language, each token (or word) is associated with a specific query vector that encodes what that token is “looking for” in other tokens within the sequence. In many embodiments, these query vectors are produced by multiplying the token embeddings by a learned weight matrix specific to the queries. The query serves as a way for the model to actively seek out relevant information from other tokens, allowing it to identify connections or dependencies between different parts of the sequence. Thus, queries capture the intention or focus of each token as it interacts with the rest of the input.

K is associated with the key matrix consisting of “key” vectors, which are similarly derived from the input sequence. Each token has an associated key vector that represents the essential information it holds. While queries represent what each token is searching for, keys encode what each token offers in terms of information. Keys are generated by multiplying token embeddings with a learned weight matrix distinct from that used for queries. The relationship between queries and keys determines how strongly one token will attend to another, allowing the model to weigh the relevance of each token to each other token within the sequence.

The term QK^{T} therefore represents the dot product between the query and key matrices. This operation calculates the similarity (or relevance) between each query vector and each key vector, effectively measuring how much attention one token should give to another. The resulting score indicates how strongly each token should focus on every other token, capturing the relationships within the input sequence. This relevance score is fundamental to the attention mechanism, as it serves as the basis for distributing focus across the sequence.

Within the above equation, V stands for “value”, insomuch as a value matrix contains “value” vectors, which can represent the actual content information associated with each token. Unlike queries and keys, which often work to determine the relevance of tokens to each other, values contain the data the model will pass along through the attention layer. Value vectors are produced by multiplying token embeddings with a learned weight matrix specific to values. These value vectors carry the contextual information that the model will use when constructing output, ensuring that the information emphasized by the attention mechanism is carried forward in processing.

The division by \sqrt{dₖ} is a scaling factor where dₖ denotes the dimensionality of the query and key vectors. Without this scaling, the dot product values in QK^{T} could become large as the number of dimensions increases, which would push the SoftMax function towards extreme values, creating an unstable learning process. By scaling with \sqrt{dₖ}, the model normalizes the scores, keeping gradients more manageable and stabilizing the SoftMax output, which aids in more effective learning and model convergence.

In the embodiment depicted in FIG. 8, an input prompt of “a fluffy blue creature roamed the verdant forest” is being processed through the attention filter 800. Each of these tokens, such as the first token 810 are subject to processing through a query vector 810 shown as W_{Q}. In a very simplistic way (and described herein for illustrative purposes), the token has an associated query vector 810 that can “ask” questions in a numerical way such as, but not limited to, “are there any adjectives in front of me”? In response, words that are adjectives before the creature token 840 are more likely to be activated later on.

Specifically, each token has an associated vector/tensor written down herein as E₁, E₂ onward to E₈. Each of these vectors/tensors can be multiplied by or otherwise processed by a corresponding query matrix (shown as W_{Q}) to generate a query vector, denoted by Q₁, Q₂ onward to Q₈. Likewise, the same tokens, such as the first key token 825, second key token 835, and fourth key token 845 can be processed through a key matrix (shown as Wₖ) to generate corresponding key vectors denoted by K₁, K₂, and the like. Finally, for each token, the dot product of the query vector and key vector are determined. These values are then operated on through a type of SoftMax filter to generate a specific format of numbers such that each value will be placed between 0 and 1, and the sum off all values within a column shall be equal to 1. In this way, we can see that the “fluffy” token 820 and “blue” token 830 output a large value in association with the token “creature” as those tokens are adjectives describing the creature token 840. Similar values appear when “the” and “verdant” are compared to the token “forest”.

In a variety of embodiments, the result of this dot product is an “attention vector” that can be added to the original vector such that a new modified attention vector is created. The goal is to move the vector associated with the token to a spot on the multi-dimensional space that is closer to other related terms. This output can then be sent to one or more multi-layer perceptrons (MLPs).

Although a specific embodiment for an attention layer process 800 within a large language model suitable for carrying out the various steps, processes, methods, and operations described herein is discussed with respect to FIG. 8, any of a variety of systems and/or processes may be utilized in accordance with embodiments of the disclosure. For example, the process described herein with reference to FIG. 8 and the attention models is presented in a simplistic fashion in order to allow for increased comprehension. However, those skilled in the art would recognize that other steps or attention model types may be utilized such as, but not limited to multi-head attention, and multi-head attention. The elements depicted in FIG. 8 may also be interchangeable with other elements of FIGS. 1-7 and FIGS. 9-10 as required to realize a particularly desired embodiment.

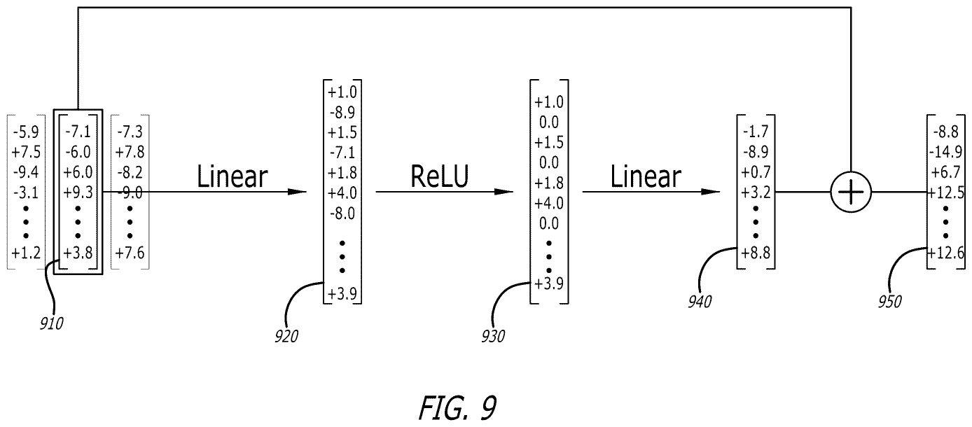

Referring to FIG. 9, a conceptual illustration of a multi-layer perceptron within a large language model in accordance with various embodiments of the disclosure is shown. In many embodiments within large language models (LLMs), multi-layer perceptrons (MLPs) play a role in refining and processing information after it has passed through the attention layers. MLPs, in the context of LLMs, are often positioned after each attention layer to add further transformations to the information embedded within each token. After the attention layer has modified each token's vector based on context and relationships with other tokens, this modified vector is then passed through an MLP. This MLP typically consists of a sequence of linear transformations, combined with a non-linear activation function, such as ReLU (Rectified Linear Unit). By applying these transformations, the MLP can help to fine-tune the representation of each token, capturing essential details and storing “factual” information that the model may rely on later.

The process can begin with a linear transformation, which expands the dimensions of the modified vector 910, essentially mapping it to a higher-dimensional space. In the embodiment depicted in FIG. 9, the original modified vector 910, which is typically an output of an attention layer, is processed through a linear transformation to yield a first output vector 920. This initial expansion can allow the MLP to encode more complex information within each vector, giving it more capacity to capture and retain meaningful details.

After this expansion, various embodiments can apply a ReLU activation function, which introduces non-linearity into the processing. ReLU is particularly effective because it enables the model to focus on positive values within the vector, setting any negative values to zero. This step allows the model to highlight certain features within the token's vector while suppressing others, helping it differentiate important from less relevant information within the encoded representation. In the embodiment depicted in FIG. 9, the ReLU output vector 930 is subsequently processed through another linear transformation.

In a number of embodiments, this second linear transformation can down-project the vector back to its original dimensionality. This step can ensure that the output from the MLP has the same dimensions as the input vector, allowing for a consistent vector size across all layers. The output vector 940 from this down-projection is then added back to the original modified vector from the attention layer, creating what's known as a residual connection 950. This residual connection 950 combines the newly refined features from the MLP with the original contextual information produced by the attention layer. This approach enhances stability during training and allows the model to retain both the relational context and the refined factual details within the token's representation.

In the broader architecture of LLMs, MLPs are often considered the component where “facts” are stored. While the attention mechanism focuses on identifying relationships and associations between tokens, essentially, contextualizing each word within the sentence structure, the MLPs focus on enriching each token's representation with more granular, content-specific details. Through the repeated application of MLPs across multiple layers, the model can accumulate and consolidate information, effectively “remembering” facts and attributes associated with different words or phrases. This allows LLMs to recall specifics about language usage, word meanings, and even broader real-world information encoded in the training data.

In contrast, the attention layers are where the “associations” are stored, focusing on dynamically adjusting each token's focus depending on its context within the input sequence. Attention layers determine how strongly each token should relate to others, capturing nuances like syntax, grammar, and context-sensitive meanings. While attention layers dynamically build context, MLPs hold onto factual representations that serve as the knowledge base within each layer. Together, the attention and MLP layers enable the model to balance understanding relationships with retaining concrete information, resulting in a robust representation of both context and knowledge.

In a number of embodiments, input data often passes through multiple rounds of attention filters and multi-layer perceptron (MLP) layers, forming a sequence of transformations that incrementally refine the model's understanding of the input before reaching the final output stage. Each layer in the transformer model, the architecture commonly used for LLMs, includes both an attention component and an MLP component, with these two parts working in tandem to progressively deepen the model's comprehension of the text. This sequence is repeated over numerous layers, allowing the model to develop a sophisticated representation of the entire input sequence through cumulative transformations. By the end of these repeated passes, each token vector holds a highly nuanced, multi-dimensional understanding of the prompt. Once all layers have processed the data, the final, refined vectors proceed to the unembedding stage, where they are mapped back to language tokens that represent the model's predicted output.

Although a specific embodiment for a multi-layer perceptron within a large language model suitable for carrying out the various steps, processes, methods, and operations described herein is discussed with respect to FIG. 9, any of a variety of systems and/or processes may be utilized in accordance with embodiments of the disclosure. For example, as those skilled in the art will recognize, the specific layout and structure of the MLP layer can vary depending on the specific application desired. The elements depicted in FIG. 9 may also be interchangeable with other elements of FIGS. 1-8 and 10 as required to realize a particularly desired embodiment.

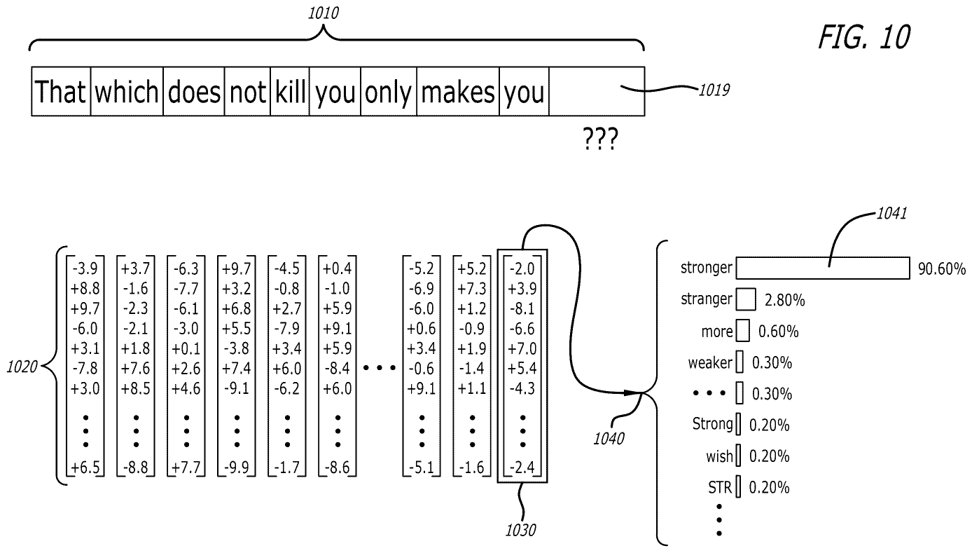

Referring to FIG. 10, a conceptual illustration of an unembedding process within a large language model in accordance with various embodiments of the disclosure is shown. In many embodiments, the final stage of a large language model's (LLM) processing is called unembedding, where it transforms the refined vectors from the last layer back into a probability distribution over potential output tokens. This stage is useful because it can allow the model to generate language tokens that represent the most likely continuations or responses to the input prompt. To achieve this, each vector (representing a token in the sequence) is mapped back to the model's vocabulary, which may contain tens of thousands of possible tokens. Unembedding utilizes a learned matrix, similar to the embedding matrix used at the input stage, but in reverse. Instead of converting tokens into vectors, it translates the processed vectors back into a set of potential language tokens that the model can output.

In a number of embodiments, the matrix output 1020 from the unembedding process is a final array 1030 where each entry corresponds to a probability score for a potential token. This probability distribution indicates how likely each word or phrase is to follow the input sequence, based on the context the model has built through its layers of attention and MLP processing. For instance, if the input prompt 1010, such as in the embodiment depicted in FIG. 10, is “That which does not kill you only makes you,” the unembedding process will produce a ranked list of possible next words. In this case, the word “stronger” might appear as the most probable continuation, with a high probability score. In FIG. 10, the probability of the “stronger” token response 1041 within the list of possible token responses 1040 is shown as 90.60 percent. This reflects the model's understanding of common phraseology and context, identifying “stronger” as a likely completion due to its frequency and relevance in similar contexts within the training data.

The ranked list produced during unembedding may include other potential outputs, each with an associated probability score that indicates its relative likelihood. For example, the word “stranger” could appear as a less probable continuation, with a probability of 2.80 percent, still present in the ranked list but much lower than “stronger.” This ranking reflects the model's capacity to recognize alternative continuations, including those that might follow less conventional but still possible language patterns. Other words, such as “more” or “weaker,” may also appear on this list, each with its own probability based on the contextual and semantic associations the model has learned. This probabilistic approach allows the model to produce flexible responses and make informed guesses about the next token in a way that mimics human language prediction.

The unembedding process may not only provide a ranked list of potential next words but also enable the model to maintain flexibility in generating responses. Depending on the application, the model might choose the highest-ranked token for a precise and likely output, or it could sample from the probability distribution to introduce variability, which can be useful in creative text generation or conversational applications. By examining the distribution of probabilities across potential tokens, the model can adapt its output strategy to different tasks, choosing the most probable word for accuracy or exploring lesser probable options for creative responses. This versatility is one of the reasons LLMs are effective across diverse language tasks, from completing sentences to generating open-ended stories.

The probability distribution generated in the unembedding phase reflects the culmination of all previous processing steps, encapsulating the context, associations, and factual information encoded within the model. Each token's probability is informed by the layers of attention and MLP transformations, which allow the model to build a nuanced understanding of the input. By ranking potential outputs, the model can provide a final “decision” on the next token based on its understanding, with the unembedding process acting as a bridge between the abstract, high-dimensional vector space within the model and the concrete language output we see.

In further embodiments, the LLM can generate entire sequences of text by using its own output as the input for subsequent steps, allowing it to create a series of tokens that form coherent responses or passages. Once the model generates a probable next token, it can feed this token back into its input pipeline, treating it as the next part of the prompt. This iterative process enables the model to build on each newly generated token, maintaining continuity and context with each step. For example, if the initial prompt is “The sky is,” and the model predicts “blue” as the most probable next word, it can then take “The sky is blue” as the new input. By repeating this cycle, the LLM can produce extended responses, updating its understanding of context and adjusting its predictions as it goes along. This feedback loop allows the model to generate complex, contextually aligned sequences, whether for completing sentences, generating stories, or engaging in conversational responses, all by sequentially predicting and incorporating each token into its evolving context.

Although a specific embodiment for an unembedding process within a large language model suitable for carrying out the various steps, processes, methods, and operations described herein is discussed with respect to FIG. 10, any of a variety of systems and/or processes may be utilized in accordance with embodiments of the disclosure. For example, the output for other types of models can be token related to images, sounds, or other data format types. The elements depicted in FIG. 10 may also be interchangeable with other elements of FIGS. 1-9 as required to realize a particularly desired embodiment.

### I. Active Learning System

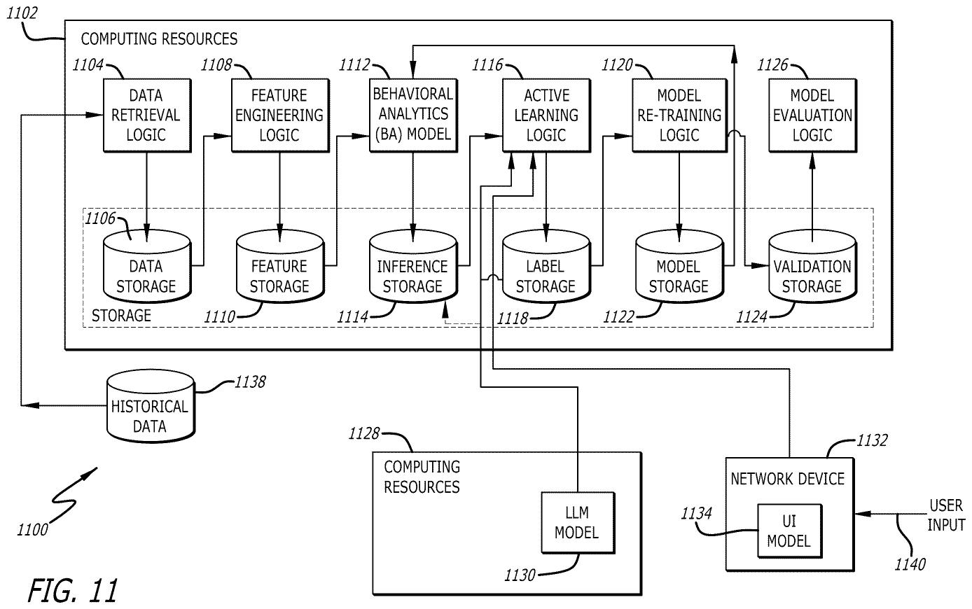

Referring now to FIG. 11, an architectural diagrammatic illustration of components forming an automated label generation, model retraining, and active learning system (“active learning system”) 1100 is shown according to an implementation of the disclosure. The active learning system 1100 is shown to include logic operating on various computing resources such as the computing resources 1102 and the computing resources 1128. It should be understood that while the computing resources 1102, 1128 are illustrated as being separate resources, the computing resources 1102, 1128 such may be implemented in different forms. For instance, cloud computing storage may refer to physical storage located one or more data sets, where the storage of data is abstracted for users for access using a network connection through a uniform resource locator (URL) or a webpage UI, a command line interface, a software development kit (SDK), etc. Generally, cloud computing resources are segmented into availability zones (e.g., based on geographic region), where data may be replicated across multiple availability zones to ensure durability and availability. Thus, the computing resources 1102 may refer to cloud computing storage being within the same availability zone, the same data center, or in different availability zones or different data centers.

More generally, the computing resources 1102, 1128 may refer to a fully managed compute platform for running analytics applications. In one embodiment, the computing resources 1102 may refer to the Amazon Web Services (AWS) Elastic MapReduce (EMR) serverless platform. The storage included in the computing resources 1102, 1128 may refer to cloud computing storage, with one example being Amazon Simple Storage Service (S3) buckets. The computing resources 1102 is shown to include several logic modules and several storages, e.g., S3 buckets. The logic modules may include a data retrieval logic 1104, a feature engineering logic 1108, a behavioral analytics (BA) model 1112, an active learning logic 1116, a model re-training logic 1120, and a modal evaluation logic 1126. The storages coupled to one or more of the logic modules listed above may include a data storage 1106 for storing historical data 1138, a feature storage 1110 for storing features extracted from the historical data 1138, an inference storage 1114 for storing inferences may be the BA model 1112, a label storage for storing probabilistic labels generated by the LLM 1130, a model storage 1122 for storing the BA model 1112 and, optionally, the LLM 1130 as well as any past versions of either, and a validation storage 1124 for storing validation results of validation processes performed on re-trained versions of the BA model 1112 before deployment thereof (and optionally of the validation results of the LLM 1130, if such is performed).

In some instances, the BA model 1112 nay refer to a machine learning model or statistical analytics logic that is trained or configured to detect anomalous or suspicious behavior through the establishment of a baseline (normal activity) and then identifying deviations from the baseline in subsequently received or processed data.

In one specific implementation, the data retrieval logic 1104 is configured to query parquet data in one or more S3 buckets using a serverless interactive query service that enables direct analysis of stored data using Standard Query Language (SQL) code. In one instance, the serverless interactive query service may be AWS Athena, which is used to query a data storage (S3 bucket) for the historical data 1138. In other implementations, the data retrieval logic 11104 may automate the data retrieval process by establishing a rule that is triggered upon arrival of new historical data 1138. An automated function of the data retrieval logic 11104 may call AWS Athena to retrieve the new historical data 1138, process the historical data to extract features, which are stored in a feature storage 1110.

Additionally, both the computing resources 1102, 1128 are shown to interact with the network device 1132, which may refer to sending and receiving of data including a subset of the historical data having probabilistic labels for data objects of the historical data (e.g., logs) generated by the LLM model 1130 with low confidence (which may merely mean the subset having the lowest confidence for a set of probabilistic labels) for display on a user interface (UI) generated by a UI logic 1134. The UI logic 1134 is configured to receive the user input 1140 corresponding to labels for data objects of the subset of historical data determined by a subject matter expert, e.g., a human, which are passed to the active learning logic 1116. Additional details of the logic modules illustrated in FIG. 11 are discussed below.

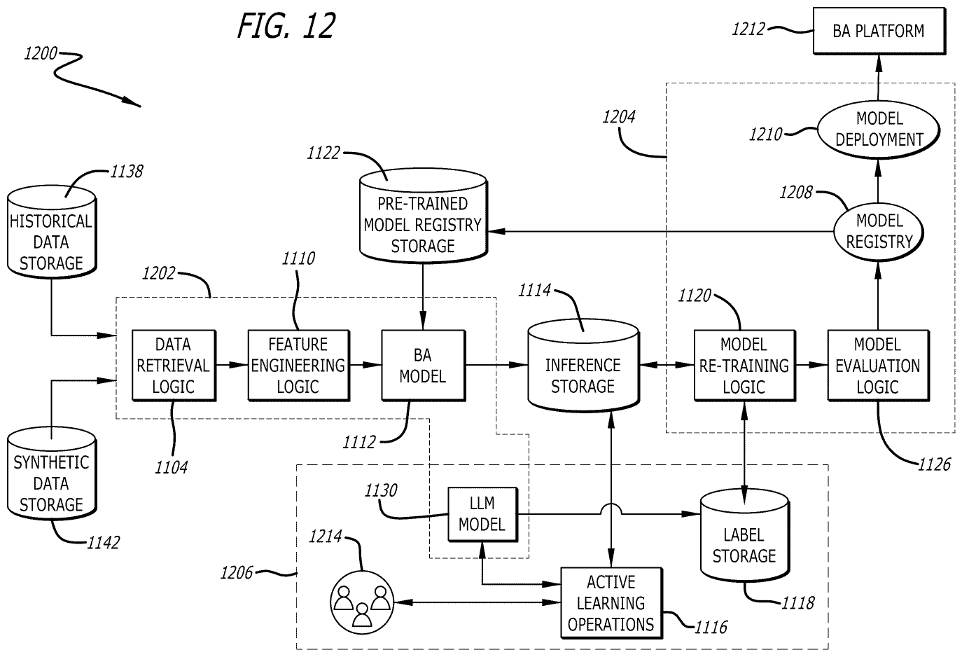

Referring to now FIG. 12, a diagrammatic illustration comprising a set of pipelines for automated label generation, model retraining, and an active learning process is shown according to an implementation of the disclosure. FIG. 12 shows a networked environment 1200 that includes the active learning system 1100 of FIG. 11, where the active learning system 1100 is illustrated as being formed of three pipelines 1202, 1204, and 1206. The first pipeline 1202 represents an automated label generation that encompasses inferencing by the BA model 1112. The first pipeline 1202 includes the data retrieval logic 1104, the feature engineering logic 1110, the BA model 1112. As shown, the first pipeline 1202 includes the data retrieval logic 1104 obtaining historical data 1138, which is processed by the feature engineering logic 1110 resulting in the extraction of features for each data object (e.g., log) within the historical data 1138, providing the extracted features to the BA model 1112. The BA model performs inferencing on the extracted features based on its training and generates a label for each of the logs such as suspicious, benign, or in some examples, malicious. The inferencing results generated by the BA model 1112 may be stored in the inference storage 1114.

The second pipeline 1204 represents an automated model re-training that encompasses operations to automatically re-train the BA model 1112 or the LLM 1130 based on monitoring the accuracy of the inferencing of each model. The second pipeline 1204 includes the model retraining logic 1120, the model evaluation logic 1126, an operation 1208 of storing the re-trained BA model 1112 in a model storage 1122, and an operation 1210 of deploying the re-trained BA model 1112 in a BA platform 1211, where the BA model 1112 analyzes log data in the same manner as in the pipeline 1202 and causes generation of alerts of suspicious logs. A re-trained LLM 1130 may also be stored in the model storage 1122, in alternative storage, such as on separate cloud computing resources or as non-transitory, computer-readable medium of a network device, e.g., such as local computing resources of an enterprise.

The third pipeline 1206 represents an active learning process that encompasses operations of monitoring the performance of generating inference results, e.g., probabilistic labels, by the LLM 1130. The third pipeline 1206 includes the LLM 1130 performing inferencing on the historical data 1138 and an active learning logic 1116 that obtains the data objects having the lowest confidence score with respect to the data object's probabilistic label generated during inferencing and provides those logs to a subject matter expert, such as a security operations center (SOC) analyst, for review. The active learning logic 1116 receives user input from the subject matter expert via a network device, e.g., through a graphical user interface (GUI) displayed on a display screen of the network device, which indicates the subject matter expert's input on whether each reviewed data object is suspicious or benign (or optionally, malicious). Based on the user input from the subject matter expert, the active learning logic 1116 determines whether the LLM 1130 has incorrectly labeled a threshold percentage of data objects, and when such is the case, the active learning logic 1116 triggers the model re-training logic 1120 to perform a re-training process on the LLM 1130. A re-trained LLM 1130 may also be stored in the model storage 1122, in alternative storage, such as on separate cloud computing resources or as non-transitory, computer-readable medium of a network device, e.g., such as local computing resources of an enterprise.

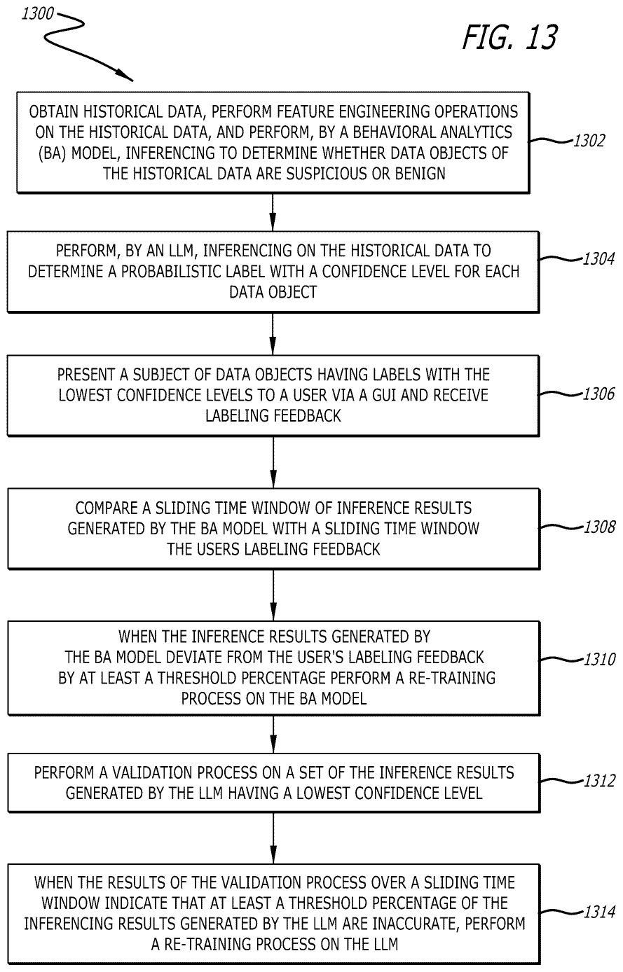

Referring to FIG. 13, a flowchart illustrating example operations for performing operations illustrated in FIG. 12 of automated label generation, model retraining, and an active learning process is shown according to an implementation of the disclosure. Each block illustrated in FIG. 13 represents an operation in the process 1300 performed by, for example, the active learning system of FIGS. 11-12. It should be understood that not every operation illustrated in FIG. 13 is required. In fact, certain operations may be optional to complete aspects of the process 1300. The discussion of the operations of process 1300 may be done so with reference to any of the FIGURES described herein.

The process 1300 begins with an operation of obtaining historical data, performing feature engineering operations on the historical data, and performing, by a behavioral analytics (BA) model, inferencing to determine whether data objects of the historical data are suspicious or benign (block 1302). Additionally, a large language model (LLM) performs inferencing on the historical data to determine whether data objects of the historical data are suspicious or benign (block 1304). In performing inferencing, the LLM may determine a probabilistic label for each log, which may represent a confidence score that a particular log is suspicious (or benign, or even malicious) depending on the configuration and training of the LLM.

In one example, the historical data refers to historical log data comprising a plurality of logs and a data object may refer to an individual log. The plurality of logs may represent recordings of activities or occurrences during operation of one or more network devices. Further, each recording may include or involve a script or executable file. In such an example, the historical log data may be analyzed by the BA model of the active learning system to determine whether the data log is a suspicious PowerShell script. Suspicious PowerShell scripts may be dangerous to a network device or an enterprise when a network device infected with a malicious script connects to its network as PowerShell scripts typically have inherent deep access to system resources, often with the ability to read/write files, modify a registry, manage processes and services, call .NET framework classes, and interact with remote systems. This inherent deep system access and typical functionality enables cyberattackers to perform nefarious actions such as installing malware, disable antiviruses, or exfiltrate data, for example.

The BA model may be trained and configured to receive features of a log and determine whether the features indicate that the log is a suspicious PowerShell script. This is often a complex task due to sophisticated attempts by cyberattackers to obfuscate or otherwise disguise the PowerShell script to avoid detection. In particular, as PowerShell is a scripting language that is built-in to the Windows operating system provided by Microsoft Corporation, of Redmond, Washington, which makes detection difficult as no external or custom binaries need to be inserted into and executed by an application or an operating system of a network device.

Following the inferencing by the LLM, a subset of data objects are presented to a user via a graphical user interface (GUI), where the subset of data objects are those that have the lowest confidence levels as determined by the LLM (block 1306). The GUI is configured to receive labeling feedback from a user indicating whether each of the data objects presented on the GUI are suspicious or benign.

A comparison may then be performed between a sliding time window of the inference results generated by the BA model with a sliding time window of the user's labeling feedback (block 1308). In the comparison, the sliding time windows correspond to the same time periods. The comparison is intended to determine whether the two machine learning systems are generating the same results for each log. The sliding time window is used in order to determine how well the BA model is inferring whether the historical data is suspicious in view of the user's labeling feedback over time. Thus, the intent is to not how well the BA model has performed in its analysis of all historical data but more so how well the BA model has performed recently, e.g., over the past 100, 1000, 5000 logs, etc., with the understanding that when the accuracy of the inference results generated by the BA model in view of the user's labeling feedback fails to satisfy a threshold comparison, e.g., meet or exceed a threshold accuracy percentage, the active learning system automatically initiates a model retraining process on the BA model (block 1310). As will be discussed below, the re-training model process for the LLM may include re-training on historical data having labels that were generated during time windows in which the least confident probabilistic labels were validated by a subject matter expert, historical data having “golden labels,” and/or synthetic data having labels generated by humans/administrators or the LLM during time windows in which the least confident probabilistic labels were validated by a subject matter expert.

As used herein and as understood by those of ordinary skill in the art, a golden label in the cybersecurity context refers to a label such as suspicious, malicious, benign, etc., that is assigned to a data entry or data point, is used in training and evaluating machine learning or statistical models in performance of various cyberthreat detections, and is taken as correct, verified, and truth (generally, a “ground truth”) following verification through trusted measures such as human-in-the-loop validation (subject matter expert manually verifies label) and/or crowdsourcing where analysts and/or tools verify such labels at a large scale.

Additionally, as the LLM generates inference results, such as probabilistic labels indicating whether a log is suspicious, the active learning system monitors the performance of the LLM through performance of a validation process (block 1312). The validation process may include retrieving the logs having the lowest confidence score with respect to the log's probabilistic label and providing those logs to a subject matter expert, such as a security operations center (SOC) analyst, for review. The subject matter expert provides user input via a network device, e.g., through a graphical user interface (GUI) displayed on a display screen of the network device, which indicates the subject matter expert's input on whether the log includes or involves a suspicious PowerShell script.

The logs retrieved for review by the subject matter may be a subset of the logs included within a particular sliding time window. For example, if a particular sliding time window includes 10,000 logs, the active learning system may retrieve 10 (0.1%) or 100 (1%) of the logs that have the lowest confidence score associated with the probabilistic label. Stated differently, the active learning system automatically selects the logs that the LLM is least confident about with respect to its probabilistic label and provides a subject matter expert with this subset of logs.

When results of the validation process, i.e., the LLM-generated probabilistic labels in view of the subject matter expert's labeling, indicates that at least a threshold percentage of the LLM-generated probabilistic labels are not consistent with the labels provided by the subject matter expert, the active learning system automatically performs a model re-training process on the LLM (block 1314). As will be discussed below, the re-training model process for the LLM may include re-training on synthetic data, or actual historical data with “golden labels,” if available.

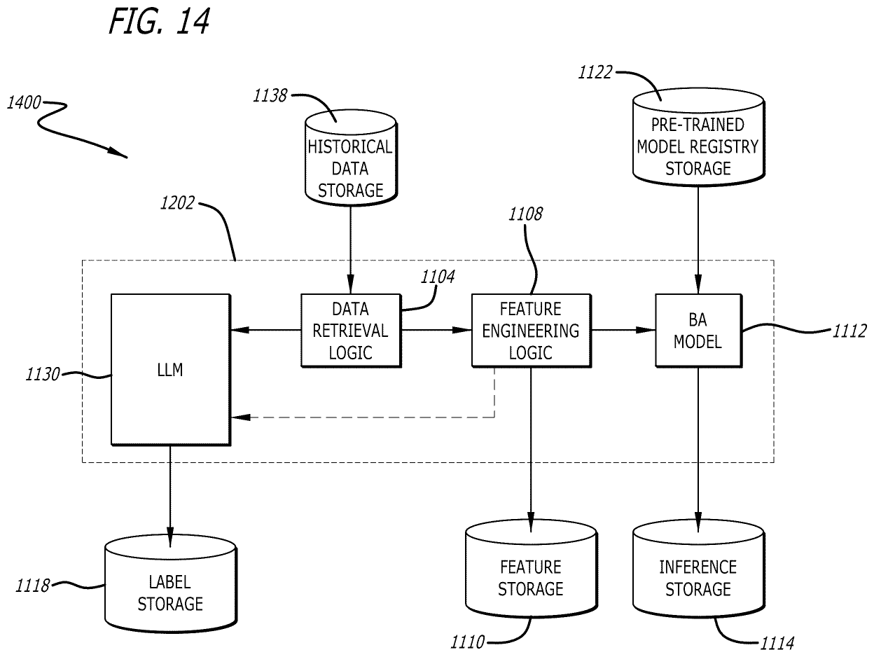

Referring now to FIG. 14, a diagrammatic illustration of a first pipeline (such as the first pipeline 1202) for automated label generation is shown according to an implementation of the disclosure. The first pipeline 1202 represents an automated label generation process 1400 that encompasses inferencing by both the BA model 1112 and the LLM 1130. The first pipeline 1202 includes the data retrieval logic 1104, the feature engineering logic 1110, the BA model 1112, and the LLM 1130. As shown, the first pipeline 1202 includes the data retrieval logic 1104 obtaining historical data 1138, which as discussed above, may be historical log data.

The historical data is passed to the feature engineering logic 1108, which is configured to extract features from each of the data objects within the historical data 1138. The feature engineering logic 1108 may perform various feature engineering operations resulting in the extraction of the features including applying mathematical transformations such as Logarithmic or exponential transforms, polynomial transforms, ratios, normalization or standardization, etc. Additionally, or alternatively, the feature engineering logic 1108 may perform categorical feature extraction such as one-hot encoding, frequency encoding, label encoding, etc. Yet other feature engineering operations may include text feature extraction (e.g., Bag of Words, generation of N-grams, named entity recognition (NER)), statistical aggregations, regex extraction of patterns or structured fields, etc. The extracted features are passed to the BA model 1112 for inferencing, resulting in a determination as to whether each data object is suspicious. The extracted features may be stored in the feature storage 1110 and the inference results generated by the BA model 1112 may be stored in the inference 1114. Additionally, the historical data may be passed from the data retrieval logic 1114 to the LLM 1130 for the LLM 1130 to infer over the plain text of the data objects comprising the historical data 1138 and determine probabilistic labels for each data object, which may be stored in label storage 1118, and/or optionally, the inference storage 1114. In some instances, the extracted features are provided to the LLM 1130 in addition to (or in lieu of) the plain text of the historical data 1138.

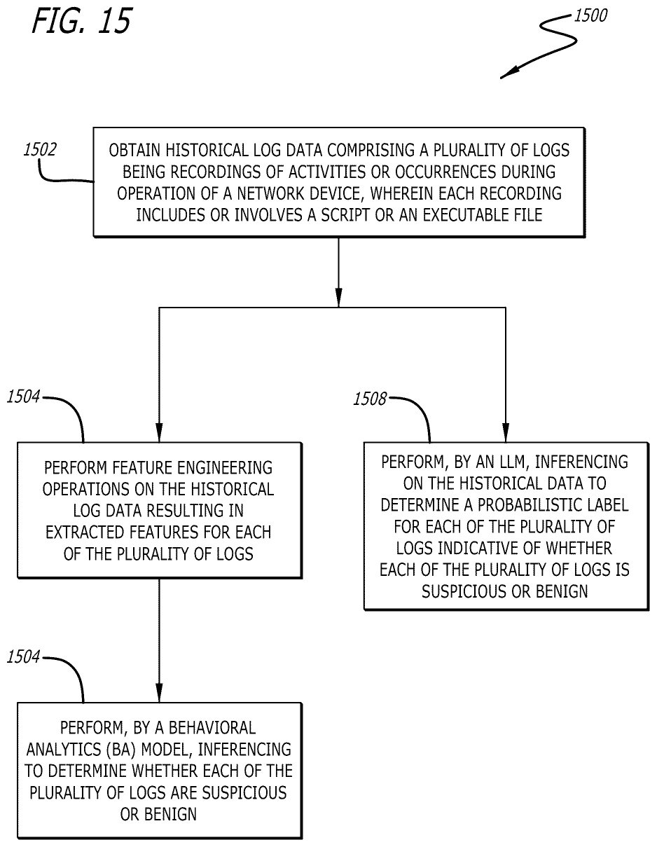

Referring to FIG. 15, a flowchart illustrating example operations for performing operations illustrated in FIG. 14 of automated label generation is shown according to an implementation of the disclosure. Each block illustrated in FIG. 15 represents an operation in the process 1500 performed by, for example, components comprising the first pipeline of the active learning system of FIGS. 11-12. It should be understood that not every operation illustrated in FIG. 15 is required. In fact, certain operations may be optional to complete aspects of the process 1500. The discussion of the operations of process 1500 may be done so with reference to any of the FIGURES described herein.

The process 1500 begins with an operation of obtaining historical data (block 1502). In some examples, the historical data may refer to historical log data comprising a plurality of logs and a data object may refer to an individual log. The plurality of logs may be recordings of activities or occurrences during operation of one or more network devices. Further, each recording may include or involve a script or executable file. In such an example, the historical log data may be analyzed by the BA model of the active learning system to determine whether the data log is a suspicious PowerShell script.

Feature engineering operations may then be performed on the historical log data resulting in extraction of a set of features for each of the plurality of logs comprising the historical log data (block 1504). A BA model may then receive the extracted features as input and perform an inferencing to determine whether each of the plurality of logs is suspicious or benign, e.g., generate a label of suspicious or benign for each log (block 1506). Additionally, the historical log data may be provided to an LLM that is instructed to perform inferencing on the historical log data to determine a probabilistic label for each of the plurality of logs indicating whether each of the plurality of logs is suspicious or benign (block 1508). The results of the inferencing performed by both the BA model and the LLM may be stored in an inference storage.

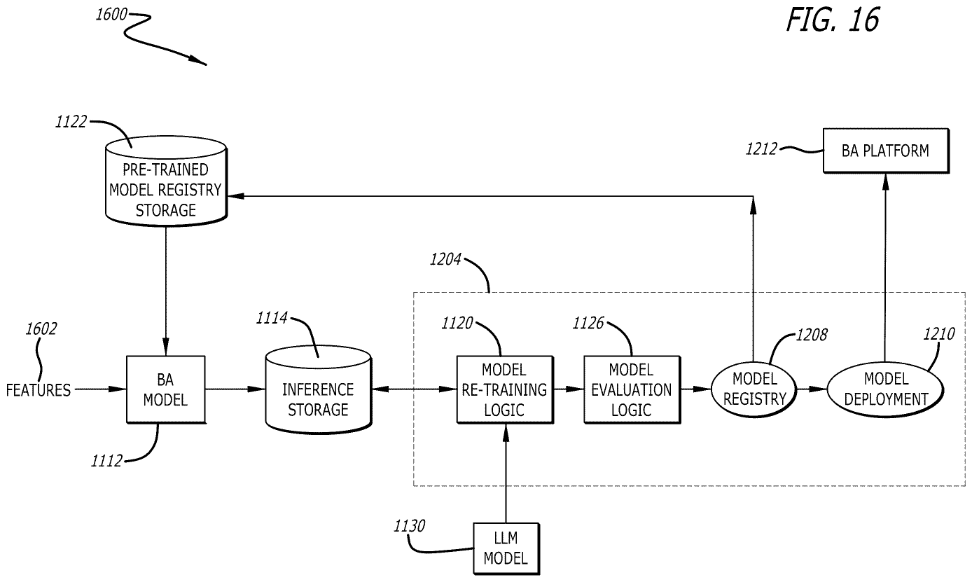

Referring now to FIG. 16, a diagrammatic illustration of a second pipeline (such as the second pipeline 1204) for model retraining is shown according to an implementation of the disclosure. The second pipeline 1204 represents an automated model re-training process 1600 that encompasses operations to automatically re-train the BA model 1112 or the LLM 1130 based on monitoring the accuracy of the inferencing of each model. The second pipeline 1204 includes the model retraining logic 1120, the model evaluation logic 1126, an operation 1208 of storing the re-trained BA model 1112 in a model storage 1122, and an operation 1210 of deploying the re-trained BA model 1112 in a BA platform 1211, where the BA model 1112 analyzes log data in the same manner as in the pipeline 1202 and causes generation of alerts of suspicious logs. A re-trained LLM 1130 may also be stored in the model storage 1122, in alternative storage, such as on separate cloud computing resources or as non-transitory, computer-readable medium of a network device, e.g., such as local computing resources of an enterprise.

More specifically, the model re-training logic 1120 may monitor the accuracy of the BA model 1112 by comparing its inference results against the labels generated through an active learning (human-in-the-loop) procedure for the same data set (which may be a subset of the inference results that have a label with a lowest confidence as determined by the LLM 1130). For example, the historical data analyzed by the BA model 1112 may be comprised of a plurality of logs with features for each of the logs being extracted during processing in the first pipeline 1202 as discussed above. The BA model 1112 determines whether each log is suspicious or benign (or, optionally, other classifications depending on training and configuration) and the inference results are stored in the inference storage 1114. Each log may include a timestamp as a field, or the timestamp may be included in metadata enabling the historical data to be partitioned into sliding time windows. Through an active learning procedure, the LLM 1130 obtains the same historical data (comprising the same logs) and determines confidence levels for the labels that were generated by the BA model 1112. As discussed below, a subset of the logs that have labels having the lowest confidence (e.g., bottom 10%, bottom 5%, bottom 1%, or a predefined number) are provided to a user via a graphical user interface that is configured to receive input from the user as to whether each log entry is suspicious or benign (or unknown). Subsequently, a comparison of the labels determined by the BA model 1112 and the user feedback is performed according to sliding time windows is to enable the active learning system 1100 to determine how the BA model 1112 is performing over a recent time period (specifically with the logs with labels having the lowest confidence levels) in order to determine when to initiate a re-training process on the BA model 1112. For example, initiating a re-training of the BA model 1112 after a single inaccurate label would be an inefficient use of computing resources and result in far too many re-trainings. Differently, if the entirety of all labels were considered, likelihood would be that the accurate labeling over time would skew the determination and result in too few re-trainings. However, comparing labels generated by the BA model 1112 and the user feedback during a sliding time window enables the active learning system 1100 to determine how the BA model 1112 is currently performing. Thus, as the BA model 1112 begins to generate inaccurate labels, the sliding time window will emphasize the inaccuracies with a higher percentage of the sliding time window being label inaccurate over a recent time period such that when the percentage of inaccurate labels meets or exceeds a threshold, the active learning system 1100 initiates a re-training.

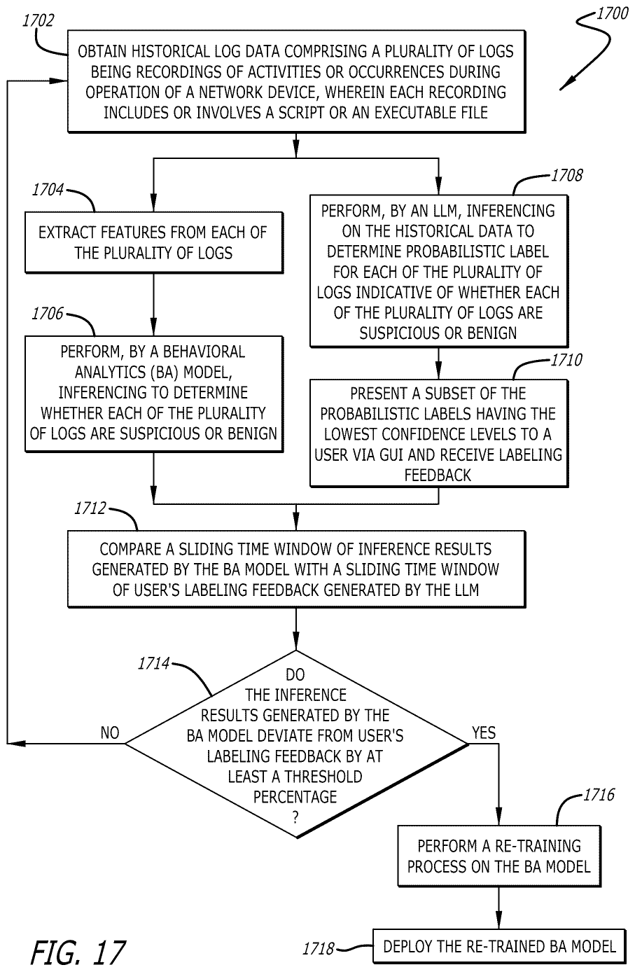

Referring to FIG. 17, a flowchart illustrating example operations for performing operations illustrated in FIG. 16 of model retraining is shown according to an implementation of the disclosure. Each block illustrated in FIG. 17 represents an operation in the process 1700 performed by, for example, components comprising the second pipeline of the active learning system of FIGS. 11-12. It should be understood that not every operation illustrated in FIG. 17 is required. In fact, certain operations may be optional to complete aspects of the process 1700. The discussion of the operations of process 1700 may be done so with reference to any of the FIGURES described herein.

The process 1700 begins with an operation of obtaining historical data (block 1702). In some examples, the historical data may refer to historical log data comprising a plurality of logs and a data object may refer to an individual log. The plurality of logs may be recordings of activities or occurrences during operation of one or more network devices. Further, each recording may include or involve a script or executable file. In such an example, the historical log data may be analyzed by the BA model of the active learning system to determine whether the data log is a suspicious PowerShell script.

Feature engineering operations may then be performed on the historical log data resulting in extraction of a set of features for each of the plurality of logs comprising the historical log data (block 1704). A BA model may then receive the extracted features as input and perform an inferencing to determine whether each of the plurality of logs is suspicious or benign, e.g., generate a label of suspicious or benign for each log (block 1706). Additionally, the historical log data may be provided to an LLM that is instructed to perform inferencing on the historical log data to determine a probabilistic label for each of the plurality of logs indicating whether each of the plurality of logs is suspicious or benign (block 1708). The results of the inferencing performed by both the BA model and the LLM may be stored in an inference storage. As noted throughout the disclosure, the probabilistic label may provide a confidence level as to the labeling. Following the inferencing by the LLM, a subset of data objects are presented to a user via a graphical user interface (GUI), where the subset of data objects are those that have the lowest confidence levels as determined by the LLM (block 1710). The GUI is configured to receive labeling feedback from a user indicating whether each of the data objects presented on the GUI are suspicious or benign.

A comparison may then be performed between a sliding time window of the inference results generated by the BA model with a sliding time window of the user's labeling feedback (block 1712). In the comparison, the sliding time windows correspond to the same time periods. The comparison is intended to determine whether the two machine learning systems are generating the same results for each log. The sliding time window is used in order to determine how well the BA model is inferring whether the historical data is suspicious in view of the inference results generated by the LLM over time. Thus, the intent is to check not only how well the BA model has performed in its analysis of all historical data but also how well the BA model has performed recently, e.g., over the past 100, 1000, 5000 logs, etc., with the understanding that when the accuracy of the inference results generated by the BA model in view of the user's labeling feedback to satisfy a threshold comparison, e.g., meet or exceed a threshold accuracy percentage, the active learning system automatically initiates a model retraining process on the BA model. When the results generated by the BA model do not deviate from the results generated by the LLM by at least a threshold percentage (no at block 1714), the process 1700 returns to block 1702 and obtains subsequent historical data.

However, when the results generated by the BA model do deviate from the results generated by the LLM by at least a threshold percentage (yes at block 1714), an automated model re-training process is performed or scheduled for processing at a later time that encompasses operations to automatically re-train the BA model. For example, the re-training process may be scheduled for running during off-hours such as 12:00 am, 1:00 am, 2:00 am, etc. In some embodiments, the BA model may be re-trained using historical data and labels generated by the LLM as well as other data having “golden labels” (block 1716). The re-trained BA model may then be deployed in a BA platform 1211 (block 1718).

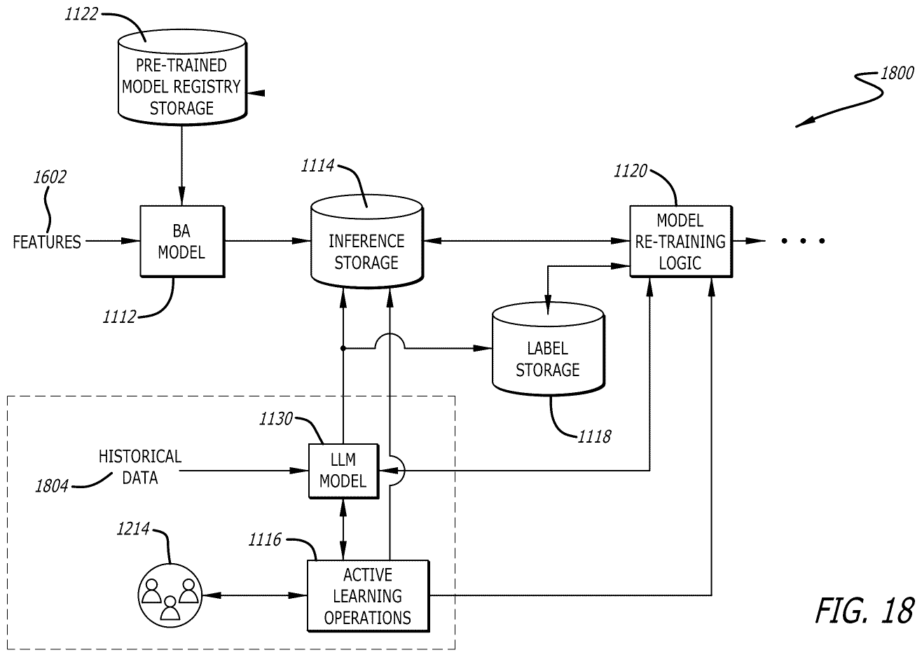

Referring now to FIG. 18, a diagrammatic illustration of a third pipeline of an active learning process is shown according to an implementation of the disclosure. The third pipeline 1206 represents an active learning process 1800 that encompasses operations of monitoring the performance of generating inference results, e.g., probabilistic labels, by the LLM 1130. The third pipeline 1206 includes the LLM 1130 performing inferencing on the historical data 1138 and an active learning logic 1116 that obtains the data objects having the lowest confidence score with respect to the data object's probabilistic label generated during inferencing and provides those logs to a subject matter expert, such as a security operations center (SOC) analyst, for review. The active learning logic 1116 receives user input from the subject matter expert via a network device, e.g., through a graphical user interface (GUI) displayed on a display screen of the network device, which indicates the subject matter expert's input on whether each reviewed data object is suspicious or benign (or optionally, malicious). Based on the user input from the subject matter expert, the active learning logic 1116 determines whether the LLM 1130 has incorrectly labeled a threshold percentage of data objects, and when such is the case, the active learning logic 1116 triggers the model re-training logic 1120 to perform a re-training process on the LLM 1130. A re-trained LLM 1130 may also be stored in the model storage 1122, in alternative storage, such as on separate cloud computing resources or as non-transitory, computer-readable medium of a network device, e.g., such as local computing resources of an enterprise.

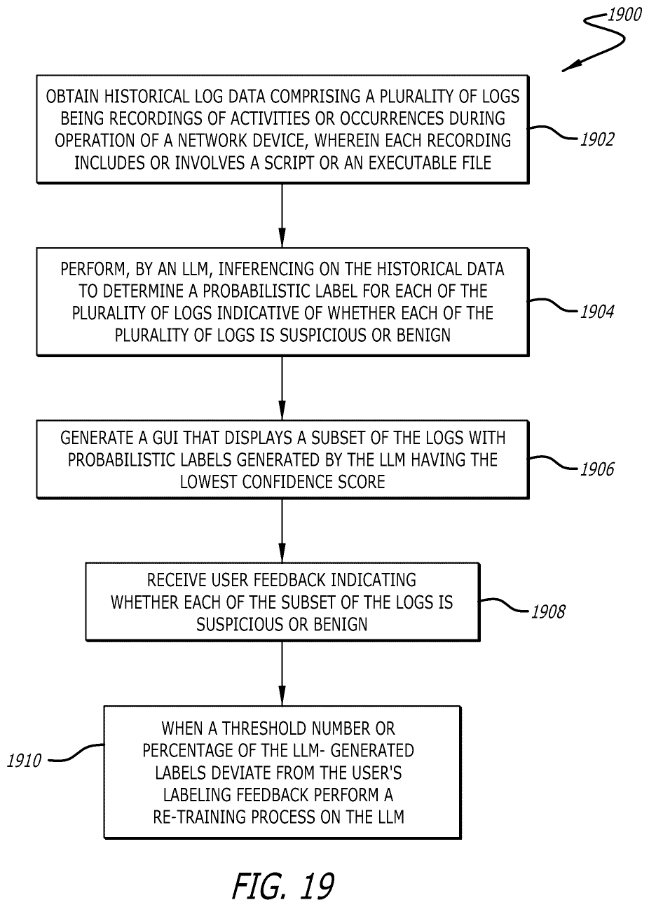

Referring to FIG. 19, a flowchart illustrating example operations for performing operations illustrated in FIG. 18 of an active learning process is shown according to an implementation of the disclosure. Each block illustrated in FIG. 19 represents an operation in the process 1900 performed by, for example, components comprising the second pipeline of the active learning system of FIGS. 11-12. It should be understood that not every operation illustrated in FIG. 19 is required. In fact, certain operations may be optional to complete aspects of the process 1900. The discussion of the operations of process 1900 may be done so with reference to any of the FIGURES described herein.

The process 1900 begins with an operation of obtaining historical data (block 1902). In some examples, the historical data may refer to historical log data comprising a plurality of logs and a data object may refer to an individual log. The plurality of logs may be recordings of activities or occurrences during operation of one or more network devices. Further, each recording may include or involve a script or executable file. In such an example, the historical log data may be analyzed by the BA model of the active learning system to determine whether the data log is a suspicious PowerShell script (or other Windows Event).

The historical data is the provided to an LLM, which performs inferencing on the historical log data to determine a probabilistic label for each of the plurality of logs comprising the historical log data indicative of whether each is suspicious or benign (block 1904). The active learning system 1100 may then generate a graphical user interface (GUI) that displays a subset of the logs for review by a subject matter expert, where the subset of logs displayed represents those having the lowest confidence levels associated with the LLM-generated probabilistic label (block 1906). The active learning system 1100 receives, via the GUI, user input corresponding to a label of suspicious or benign for the subset of logs displayed (block 1908). When the probabilistic labels generated by the LLM deviate from the user's labeling feedback by at least a threshold percentage or a threshold number of logs, a re-training procedure is performed on the LLM (block1910). For example, the re-training process may be scheduled for running during off-hours such as 12:00 am, 1:00 am, 2:00 am, etc. It should be noted that for any instance discussed here discussing threshold percentages, alternative methods or statistical measures may be utilized in the comparisons. For example, instead of a threshold percentage of deviations from one dataset to another triggering an action such as re-training, a threshold number of deviations may trigger the action. Thus, the various methods or statistical measures determining whether the comparison will result in an action generally may be referred to as “satisfying a threshold comparison.”

As noted, the re-trained LLM may be stored in the model storage 1122 and/or on alternative non-transitory storage, such as that on computing resources local to an enterprise network as compared to on cloud computing resources, for example. Additionally, the re-training of the LLM may utilize historical data with labels previously generated by the LLM (e.g., labels that were generated during time windows in which the least confident probabilistic labels were validated by a subject matter expert), historical data having “golden labels,” and/or synthetic data having labels generated by humans/administrators or the LLM during time windows in which the least confident probabilistic labels were validated by a subject matter expert.

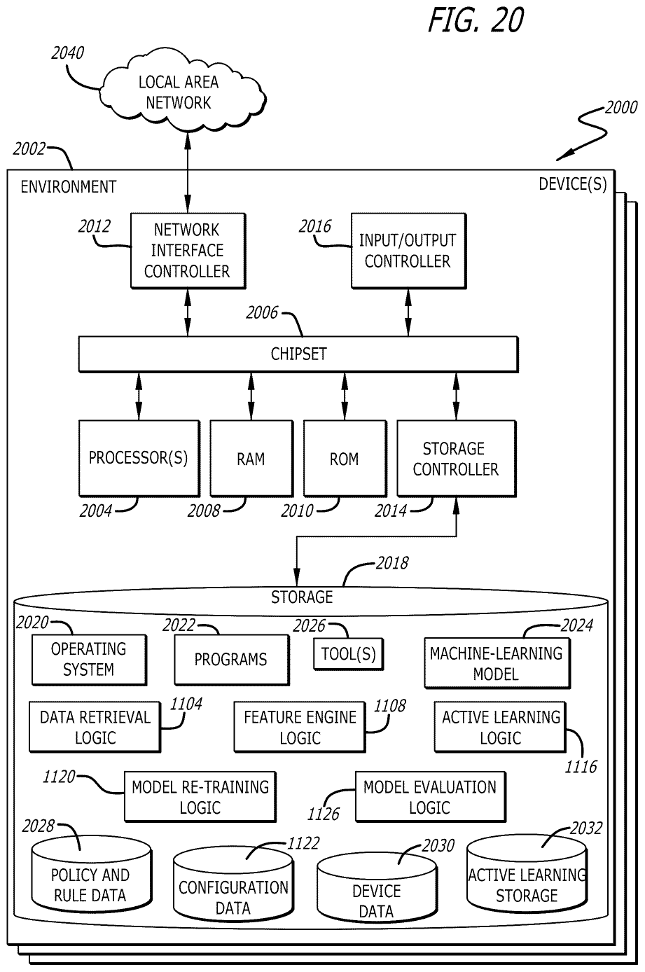

Referring to FIG. 20, a conceptual block diagram of a device suitable for configuration with an active learning system is shown according to an implementation of the disclosure. The embodiment of the conceptual block diagram depicted in FIG. 20 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 20 can also illustrate an access point, a switch, or a router in accordance with various embodiments of the disclosure. The device 2000 may, in many nonlimiting examples, correspond to physical devices or to virtual resources described herein.

In many embodiments, the device 2000 may include an environment 2002 such as a baseboard or “motherboard,” in physical embodiments that can be configured as a printed circuit board with a multitude of components or devices connected by way of a system bus or other electrical communication paths. Conceptually, in virtualized embodiments, the environment 2002 may be a virtual environment that encompasses and executes the remaining components and resources of the device 2000. In more embodiments, one or more processors 2004, such as, but not limited to, central processing units (“CPUs”) can be configured to operate in conjunction with a chipset 2006. The processor(s) 2004 can be standard programmable CPUs that perform arithmetic and logical operations necessary for the operation of the device 2000.

In a number of embodiments, the processor(s) 2004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 2006 may provide an interface between the processor(s) 2004 and the remainder of the components and devices within the environment 2002. The chipset 2006 can provide an interface to a random-access memory (“RAM”) 2008, which can be used as the main memory in the device 2000 in some embodiments. The chipset 2006 can further be configured to provide an interface to a computer-readable storage medium such as a read-only memory (“ROM”) 2010 or non-volatile RAM (“NVRAM”) for storing basic routines that can help with various tasks such as, but not limited to, starting up the device 2000 and/or transferring information between the various components and devices. The ROM 2010 or NVRAM can also store other application components necessary for the operation of the device 2000 in accordance with various embodiments described herein.

Additional embodiments of the device 2000 can be configured to operate in a networked environment using logical connections to remote computing devices and computer systems through a network, such as the network 2040. The chipset 2006 can include functionality for providing network connectivity through a network interface card (“NIC”) 2012, which may comprise a gigabit Ethernet adapter or similar component. The NIC 2012 can be capable of connecting the device 2000 to other devices over the network 2040. It is contemplated that multiple NICs 2012 may be present in the device 2000, connecting the device to other types of networks and remote systems.

In further embodiments, the device 2000 can be connected to a storage 2018 that provides non-volatile storage for data accessible by the device 2000. The storage 2018 can, for instance, store an operating system 2020, programs 2022, policy and rule data 2028, and device data 2032 which are described in greater detail below. The storage 2018 can be connected to the environment 2002 through a storage controller 2014 connected to the chipset 2006. In certain embodiments, the storage 2018 can consist of one or more physical storage units. The storage controller 2014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 2000 can store data within the storage 2018 by transforming the physical state of the physical storage units to reflect the information being stored. The specific transformation of physical state can depend on various factors. Examples of such factors can include, but are not limited to, the technology used to implement the physical storage units, whether the storage 2018 is characterized as primary or secondary storage, and the like.

In many more embodiments, the device 2000 can store information within the storage 2018 by issuing instructions through the storage controller 2014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 2000 can further read or access information from the storage 2018 by detecting the physical states or characteristics of one or more particular locations within the physical storage units.

In addition to the storage 2018 described above, the device 2000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 2000. In some examples, the operations performed by a cloud computing network, and or any components included therein, may be supported by one or more devices similar to device 2000. Stated otherwise, some or all of the operations performed by the cloud computing network, and or any components included therein, may be performed by one or more devices 2000 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 2018 can store an operating system 2020 utilized to control the operation of the device 2000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 2018 can store other system or application programs and data utilized by the device 2000.

In many additional embodiments, the storage 2018 or other computer-readable storage media is encoded with computer-executable instructions which, when loaded into the device 2000, may transform it from a general-purpose computing system into a special-purpose computer capable of implementing the embodiments described herein. These computer executable instructions may be stored as program 2022 (for example, an application) and transform the device 2000 by specifying how the processor(s) 2004 can transition between states, as described above. In some embodiments, the device 2000 has access to computer-readable storage media storing computer executable instructions which, when executed by the device 2000, perform the various processes described above with regard to any of the FIGURES discussed herein. In certain embodiments, the device 2000 can also include computer-readable storage media having instructions stored thereupon for performing any of the other computer-implemented operations described herein.

In still further embodiments, the device 2000 can also include one or more input/output controllers 2016 for receiving and processing input from a number of input devices, such as a keyboard, a mouse, a touchpad, a touch screen, an electronic stylus, or other type of input device. Similarly, an input/output controller 2016 can be configured to provide output to a display, such as a computer monitor, a flat panel display, a digital projector, a printer, or other type of output device. Those skilled in the art will recognize that the device 2000 might not include all of the components shown in FIG. 20 and can include other components that are not explicitly shown in FIG. 20 or might utilize an architecture completely different than that shown in FIG. 20.

As described above, the device 2000 may support a virtualization layer, such as one or more virtual resources executing on the device 2000. In some examples, the virtualization layer may be supported by a hypervisor that provides one or more virtual machines running on the device 2000 to perform functions described herein. The virtualization layer may generally support a virtual resource that performs at least a portion of the techniques described herein. Further, the storage 2018 includes a retriever generator module 1120 that performs operations discussed throughout the disclosure, including, with respect to FIG. 14.

In various embodiments, the storage 2018 can include the policy and rule data 2028. The policy and rule data 2028 may refer to sets of guidelines and conditions that govern how sessions and communication activities are managed within a network. The policy data can define overarching principles or objectives, such as sustainability-aware business goals, while rule data may contain the specific instructions or criteria that dictate how session activities are to be routed. For example, a policy might state that sessions should be routed through devices with lower carbon footprints, while the rules may specify the thresholds for sustainability scores or energy usage that qualify a device for handling a session. Together, the policy and rule data 2028 may ensure that network operations align with both sustainability goals and performance requirements, enabling dynamic and intelligent session routing decisions based on real-time device metrics.

In a number of embodiments, the storage 2018 can include device data 2032. The device data 2032 may refer to the detailed information and metrics about network devices or other processing attributes gathered from a network environment. The device data 2032 includes various attributes such as device type (e.g., server, edge device, or gateway), location, current load or utilization, processing capacity, CPU utilization, operational status (online/offline), and power consumption. The device data 2032 also includes connectivity characteristics like bandwidth, latency, and network type (e.g., 4G, 5G, Wi-Fi).

Finally, in numerous additional embodiments, data may be processed into a format usable by a machine-learning model 1324 (e.g., feature vectors) or other pre-processing techniques. The machine-learning (“ML”) model 1324 may be any type of ML model, such as supervised models, reinforcement models, and/or unsupervised models and may encompass all versions of the BA model 1112 and all versions of the LLM 1130 (where a new version of either is created upon each re-training) illustrated in the FIGURES herein. The ML model 1324 may include one or more of large language models, linear regression models, logistic regression models, decision trees, Naïve Bayes models, neural networks, k-means cluster models, random forest models, and/or other types of ML models 1324.

The ML model(s) 1324 can be configured to generate inferences to make predictions or draw conclusions from data. An inference can be considered the output of a process of applying a model to new data. This can occur by learning from at least historical data labeled using the LLM 1130 or having “golden labels” as verified by humans/administrators, synthetic data generated by human/administrator verifications or generative artificial intelligence (AI) methodologies, and utilize the learning to predict future outcomes. For example, the ML model(s) 1324 can be utilized for labels indicating a level of suspiciousness for received data objects such as logs generated by network devices. Unsupervised learning methods, such as k-means clustering, can detect hidden patterns in network behavior and resource usage. To train the ML model 1324, a training dataset of data objects, e.g., logs, with known attributes and labels, e.g., suspiciousness scores, can be utilized. Preprocessing and feature extraction may be performed to identify the most important data points. This refined data is used to train the ML model(s) 1324, allowing it to learn relevant patterns.

Once trained, the ML model 1324 may be integrated into the device 1300 to make real-time decisions or predictions as well formulate answers to user queries (as an LLM). These predictions are based on patterns and relationships discovered within the data. To generate an inference, the trained model can take input data and produce a prediction or a decision. In various instances, the input data can be in various forms, such as log files, images, audio, text, or numerical data, depending on the type of problem the model was trained to solve. The output of the model can also vary depending on the problem, and can be a single number, a probability distribution, a set of labels, a decision about an action to take, a natural language response to a user query, etc. Ground truth for the ML model(s) 1324 may be generated by human/administrator verifications or may compare predicted outcomes with actual outcomes.

In addition embodiments, the storage 2018 includes logic modules encompassing the active learning system 1100 as discussed above. Specifically, the storage 2018 is shown to include logic modules such as the data retrieval logic 1104, the feature engineering logic 1108, the active learning logic 1116, the model re-training logic 1120, and the model evaluation logic 1126 in addition to the ML models 1324 encompassing the BA model 1112 and the LLM 1130.

Although a specific embodiment for a device suitable for configuration with logic encompassing the active learning system 1100 for carrying out the various steps, processes, methods, and operations described herein is discussed with respect to FIG. 20, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 20 may also be interchangeable with other elements of the disclosure as required to realize a particularly desired embodiment.

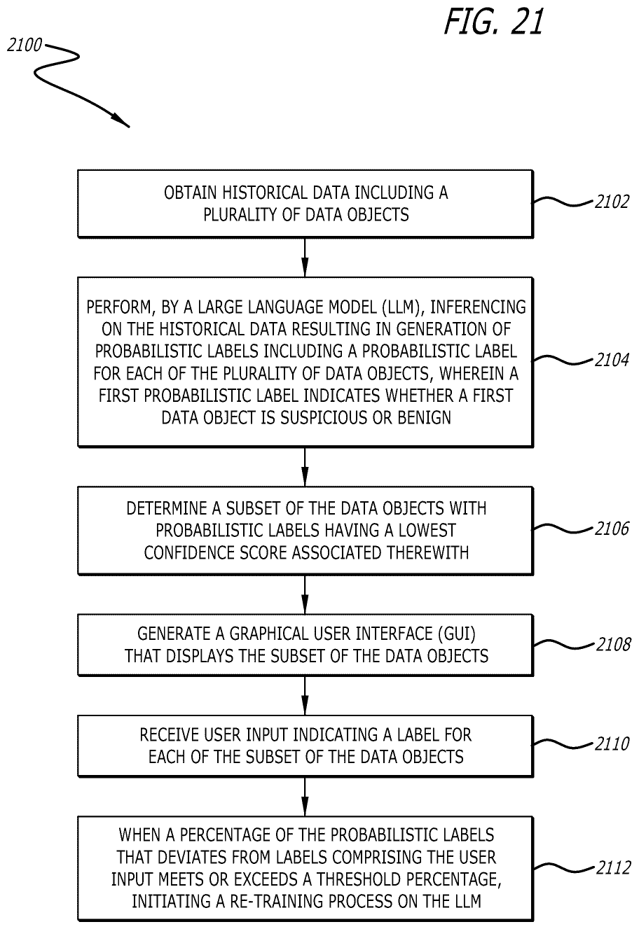

Referring now to FIG. 21, a flowchart illustrating example operations for performing an active learning process is shown according to an implementation of the disclosure. The example process 2100 can be implemented, for example, by a computing device (or network device) that comprises a processor and a non-transitory computer-readable medium. The non-transitory computer readable medium can be storing instructions that, when executed by the processor, can cause the processor to perform the operations of the illustrated process 2100. Alternatively or additionally, the process 2100 can be implemented using a non-transitory computer-readable medium storing instructions that, when executed by one or more processors, cause the one or more processors to perform the operations of the process 2100 of FIG. 21.

Each block illustrated in FIG. 21 represents an operation of the process 2100. It should be understood that not every operation illustrated in FIG. 21 is required. In fact, certain operations may be optional to complete aspects of the method 2100. The process 2100 begins with an operation of obtaining historical data including a plurality of data objects (block 2102). The historical data is provided to an LLM that is instructed and configured to perform inferencing on the historical data resulting in generation of probabilistic labels including a probabilistic label for each of the plurality of data objects, wherein a first probabilistic label indicates whether a first data object is suspicious or benign (block 2104). A subset of the data objects with probabilistic labels having a lowest confidence score associated therewith is determined (or identified) (block 2106).

A graphical user interface (GUI) that displays the subset of the data objects is generated, displayed to a user, and user input is received that indicates a label for each of the subset of the data objects (blocks 2108, 2110). When a percentage of the probabilistic labels that deviates from labels comprising the user input meets or exceeds a threshold percentage, initiating a re-training process on the LLM (block 2112).

In some implementations, the historical data comprises historical log data, wherein the plurality of data objects are a plurality of logs that represent recordings of activities or occurrences during operation of a network device, and wherein each recording includes or involves a script or an executable file. In some implementations, the script or the executable of each recording of the historical log data is a PowerShell script. In some implementations, the recordings of the historical log data are Windows Events. Windows Events are understood as activities or occurrences during operation of a network device and that are recorded by an operating system or other logging/recording application. Windows Events typically have a set structure that includes standard components such as an EventID, an EventRecordID, an ExecutionProcessID, a ThreadID, etc. An example Windows Event is as follows:

<Event xmlns=‘http://schemas.microsoft.com/win/2004/08/events/event’>
<System>
<Provider Name=‘Microsoft-Windows-Security-Auditing’ Guid=‘{54849625-5478-4994-A5BA-
3E3B0328C30D}’/>
<EventID>4688</EventID>
<Version>2</Version>
<Level>0</Level>
<Task>13312</Task>
<Opcode>0</Opcode>
<Keywords>0x8020000000000000</Keywords>
<TimeCreated SystemTime=“$TIMESTAMP$”/>
<EventRecordID>127601</EventRecordID>
<Correlation/>
<Execution ProcessID=‘4’ ThreadID=‘2212’/>
<Channel>Security</Channel>
<Computer>SesTestWin2012.SesTestDomain.local</Computer>
<Security/>
</System>
<EventData>
<Data Name=‘SubjectUserSid’>SESTESTWIN2012\splunker</Data>
<Data Name=‘SubjectUserName’>splunker</Data>
<Data Name=‘SubjectDomainName’>SESTESTWIN2012</Data>
<Data Name=‘SubjectLogonId’>0x296174</Data>
<Data Name=‘NewProcessId’>0xe90</Data>
<Data Name=‘NewProcessName’>C:\Windows\System32\runas.exe</Data>
<Data Name=‘TokenElevationType’>%%1938</Data>
<Data Name=‘ProcessId’>0x1108</Data>
<Data Name=‘CommandLine’>C:\Program Files\Git\cmd\git.exe” clone
https://github.com/dafthack/MailSniper.git C:\tools\MailSniper</Data>
<Data Name=‘TargetUserSid’>NULL SID</Data>
<Data Name=‘TargetUserName’>-</Data>
<Data Name=‘TargetDomainName’>-</Data>
<Data Name=‘TargetLogonId’>0x0</Data>
<Data
Name=“ParentProcessName”>C:\Windows\System32\WindowsPowerShell\v1.0\powershell.exe</Dat
a>
<Data Name=“MandatoryLabel”>Mandatory Label\High Mandatory Level</Data>
</EventData>

The example Windows Event is shown to include a PowerShell script, “C:\Program Files\Git\cmd\git.exe” clone https://github.com/dafthack/MailSniper.git C:\tools\MailSniper”. As a result, the Windows Event may be analyzed by one or more machine learning models as discussed herein in order to generate a label as to the suspiciousness of the PowerShell script included therein,

In some implementations, the re-training process includes re-training or fine tuning the LLM on training data that includes data objects labeled by the LLM at a previous point in time. In some implementations, the user input indicating the label for each of the subset of the data objects represents labels generated by a subject matter expert indicating whether each of the subset of the data objects is suspicious or benign. In some implementations, the operations further comprise comparing the probabilistic labels to labels generated by a second machine learning (ML) model and initiating a second re-training process on the ML model when the labels generated by the second ML model deviate from the probabilistic labels generated by the LLM at least by a second threshold percentage.

One of the biggest bottlenecks in machine learning is obtaining labeled data that may be used to train a machine learning model. Furthermore, as the data being processed by the machine learning model evolves, the machine learning model must also evolve as a stagnant model processing evolving data will produce inaccurate results. In many fields, especially in the field of cybersecurity, obtaining a sufficient amount of hand-labeled data is not only feasible due to the volume required for training and the ambiguity involved in hand-labeling.

However, the disclosure provides novel, non-obvious, and technically complex systems and methods for generating labeled training data through a combination of rules, heuristics, and existing machine learning models that is then used in re-training. Specifically, the systems and methods disclosed herein need not start with perfect labels but instead are configured to and capable of generating labels for unlabeled data.

In order to achieve such, systems and methods disclosed herein leverage existing security rules, and also utilize existing (or baseline) machine learning models, which provides a strong foundation without needing a “ground truth” label for entry data entry that forms the training data. Additionally, systems and methods disclosed herein deploy labeling functions based on domain knowledge. One advantage of deploying a plurality of labeling functions that are each derived from domain knowledge is that such an approach is scalable, which is one of the inherent difficulties in training machine learning models. Such an approach is capable of adapting to novel attack tactics by incorporating new label functions as new attack tactics are uncovered. Further, label functions that pertain to attack tactics no longer in use may be phased out. Thus, the systems and methods disclosed herein do not merely repeat the past.

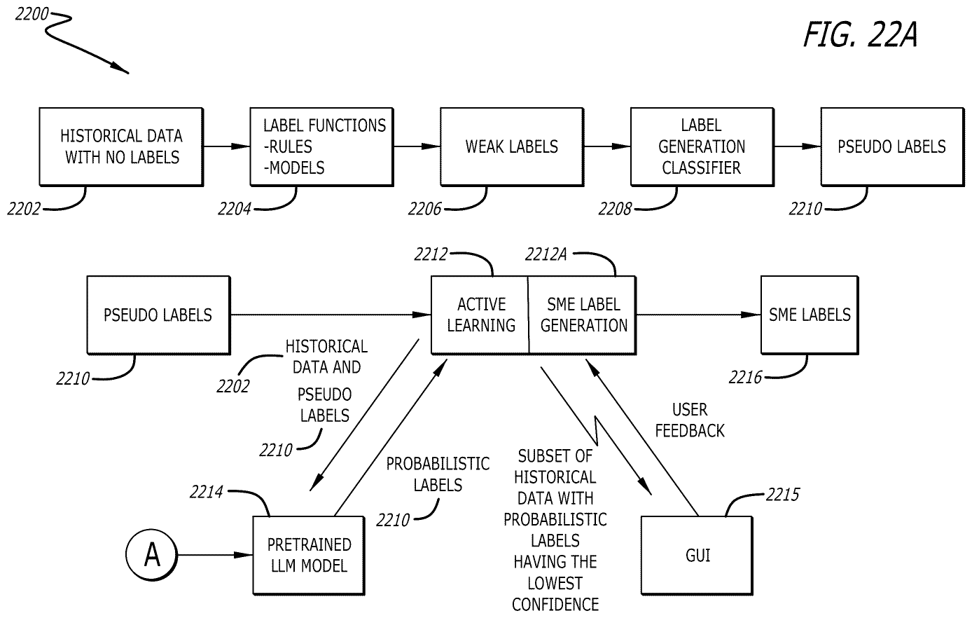

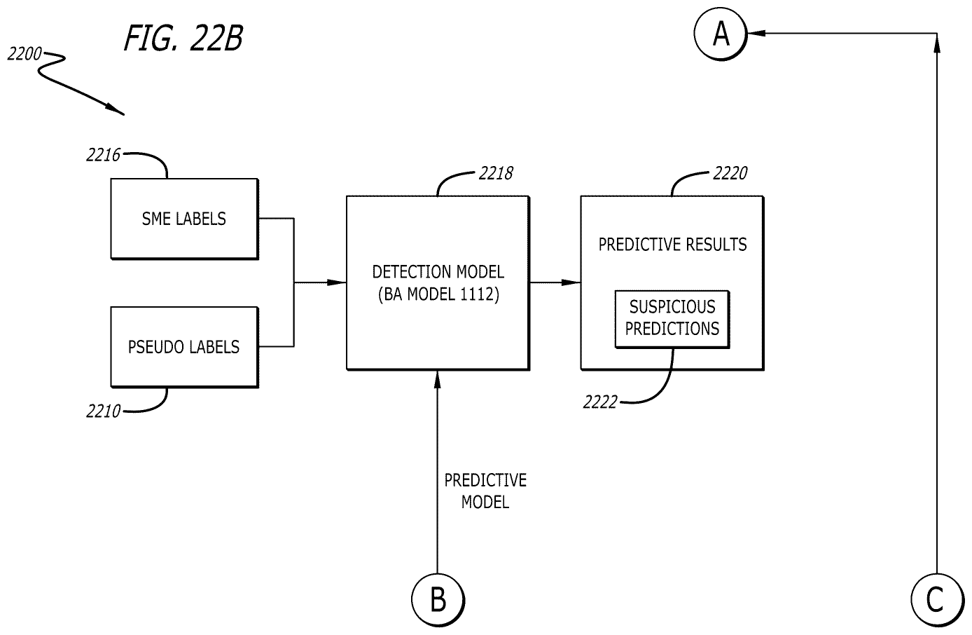

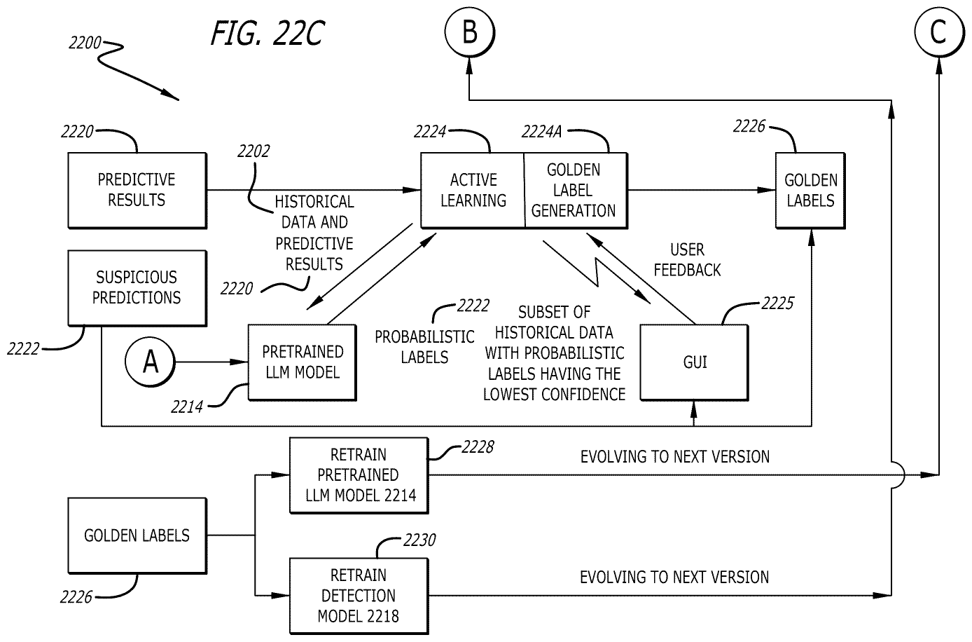

Referring now to FIGS. 22A-22C, an operational flow 2200 for performing a re-training of machine learning models by automatically generating labels for unlabeled, historical data through machine learning and active learning techniques is shown in accordance with various embodiments of the disclosure. FIG. 22A illustrates a first phase in the operational flow 2200 directed to a procedure for generating pseudo labels by a label generation classifier model and label inferences by a pretrained LLM from unlabeled historical data. FIG. 22B illustrates a second phase in the operational flow 2200 directed to generating predictive results by a detection model configured to take subject matter expert (SME) labels and pseudo labels generated by the label generation classifier model as input. Additionally, FIG. 22C illustrates a third phase in the operational flow 2200 directed to the generation of “golden labels” from predictive results and suspicious predictions (each generated earlier in the operational flow 2200) through an active learning process and subsequently utilizing the golden labels to retrain the pretrained LLM and the detection model. As should be understood, the retraining corresponds to the evolution of the pretrained LLM and the detection model.

Referring now to FIG. 22A in further detail, the operational flow 2200 begins the process of generating labels for unlabeled historical data with the application of labeling functions 2204 to unlabeled historical data 2202. In some examples, the unlabeled historical data 2202 comprises log data of Windows Events, which are understood to be activities or occurrences during operation of a network device and that are recorded by an operating system or other logging/recording application. Windows Events typically have a set structure that includes standard components such as an EventID, an EventRecordID, an ExecutionProcessID, a ThreadID, etc. An example of a Windows Event is provided above.

Label functions may be logic (or executable instructions) that, when executed, search a data entry such as a Windows Event for specific patterns and flag the presence of a pattern as suspicious. For example, a pattern may be the presence of a command containing a PowerShell command such as “Invoke-WebRequest,” which is a command used to send HTTP and HTTPS requests to web servers and often utilized to download files. The systems and methods disclosed herein include encoding each rule, heuristic, or model insight into a label function that emits a weak label. In some instances, the labeling functions 2204 may overlap in scope, and they might even conflict in their results; however, such is common and may even be expected. In fact, the overlap may be valuable by providing insight into the uncertainty to a label generation classifier model 2208, which accounts for the result of the weak labels 2206 when processing the weak labels 2206 and the unlabeled historical data.

In some implementations, one or more of the label functions 2204 may comprise artificial intelligence techniques including natural language processing (e.g., Bidirectional Encoder Representations from Transformers (BERT)) to detect patterns from data entries in the unlabeled historical data and generate a weak label corresponding to whether the data entry is benign, suspicious, or unknown (as examples). The artificial intelligence techniques may also include machine learning models and/or other LLMs that are configured to analyze each data entry, and each propose a label for each data entry. The analysis may include analyzing command semantics, generating similarity scores, and/or classifying intent based on text embeddings. The use of artificial intelligence within the label functions 2204 is technically advantageous in situations when traditional rule-based approaches typically fall short, e.g., when analyzing obfuscated commands or when an attacker modifies a tactic slightly.

A technical advantage here is seen in the ability to scale and adapt the set of label functions 2204 by adding, modifying, and/or removing individual label functions. The set of label functions 2204 may then be applied to evolving data without requiring manual annotation of the new (evolving) data entries. Such an approach enables the rapid prototyping of detection ideas (e.g., new label functions), testing of such on production-scale data, and continuously improving the set of label functions as new threats emerge.

As an example, each label function of the set of label functions 2204 may comprise a separate, invokable logic function that is configured to take a data entry (e.g., a log entry of a Windows Event) as input and process the data entry through execution of instructions resulting in a suspiciousness determination. The label functions comprising the set of label functions 2204 may be configured to provide a suspiciousness determination result of, for example, (i) suspicious or benign, (ii) suspicious or abstain (e.g., no decision), (iii) suspicious, benign, or abstain, etc.

An example label function may be as follows:

```
@labeling_function( )
def lf_suspicious_obfuscation_technique (x):
  max_num_threshold = 10
  text = x.Process_Command_Line
  count = 0
  for char in text:
    if (char == “\hat{ }” or char == “”’ or char == “\grave{ }”);
      count+=1
  if count >= max_num_threshold:
    return SUSPICIOUS
  return ABSTAIN
```

The application of the label functions 2204 to the unlabeled historical data 2202 results in the generation of a set of weak labels 2206. The set of weak labels 2206 may comprise a data structure representing the result of the application of each label function to each data entry of the unlabeled historical data 2202 (or a subset thereof). For example, the data structure may be a matrix with each row representing a data entry and each column representing a label function with the value of a particular element representing the result of the corresponding label function applied to the corresponding data entry.

The set of weak labels 2206 are then fed to a label generation classifier model 2208 resulting in a corresponding set of pseudo labels 2210. As noted above, the matrix may indicate that some label functions may conflict with one another when applied to the same data entry. Continuing to discuss the operational flow of FIG. 22A, the weak labels 2206 are then provided as input to a label generation classifier model 2208 that is configured to generate labels 2210 classifying each data entry into one of a set of classes, e.g., suspicious or abstain (indicates that the label function cannot determine whether the data entry is suspicious or benign), where such labels are referred to as “pseudo labels” 2210. Examples of the label generation classifier model 2208 include a generative adversarial network (GAN) that is understood to a be a deep generative model comprised of two neural networks including a generator and a discriminator, a Naïve Bayes model that is understood to be a probabilistic generative classifier, an expectation-maximization (EM) model, and/or other deep learning models such as autoencoders.

In some examples, the pseudo label for a particular data entry may correspond to a majority vote model, which is an aggregation of the outputs from all labeling functions with the most common label being selected. In such examples where a statistical analysis is applied, the statistical analysis would take the place of the label generation classifier model 2208 in FIG. 22A. However in other embodiments, the systems and methods disclosed herein may use generative algorithms such as Naïve Bayes, Expectation Maximization (EM), or deep learning-based models to estimate both the true label distribution and the performance of each labeling function. One technical advantage of utilizing a generative algorithm the important questions as follows may be answered: (1) Which rules are reliable?; (2) Which ones tend to conflict?; and (3) Are there hidden dependencies between labeling functions?

In practice, we often ensemble several of these approaches depending on the data complexity, label noise, and available computing resources. The takeaway here is that a label generation classifier model 2208 acts as the bridge between noisy rules and a high-quality labeled dataset, and it does so by learning the strengths and weaknesses of heuristics (the label functions 2204) automatically. The label generation classifier model 2208 becomes the foundation on which high-performing detection models may be trained.

The pseudo labels 2210 are analyzed through an active learning procedure 2212 that includes operations of (i) generating a prompt for a pretrained LLM 2214 that includes instructions to process a data entry and a corresponding predictive result and/or suspicious prediction and receiving corresponding confidence levels 2210; and (ii) providing a subset of the lowest confidence labels to a human (SME) user through a graphical user interface (GUI) 2215 with user feedback received corresponding to a human (SME) labeling as to whether each data entry is suspicious or benign. Subsequently, an SME label generation logic 2212A associated with the active learning procedure 2212 then generates the SME labels 2216 from the user feedback. While FIGS. 22A and 22C refer to a pretrained LLM, alternatives embodiments may deploy a transformer-based model such as a bidirectional encoder representations from transformers (BERT) model, SecBERT (a fine-tuned version of BERT for the security space) or another encoder-based model.

Referring now to FIG. 22B, the second phase in the operational flow 2200 illustrates the generation of predictive results 2220 by a detection model 2218 that is configured to take the SME labels 2216 and the pseudo labels 2210 generated by the label generation classifier model 2208 as input. As shown, the SME labels 2216 and the pseudo labels 2210 are provided to the detection model 2218, which may correspond to the BA model 1112 discussed above. The detection model 2218 generates predictive results 2220 that indicate whether each of the data entries are suspicious or benign based on the data entry itself as well as the SME label for the data entry and/or the pseudo label 2210 for the data entry. In many instances, at least a subset of the predictive results 2220 may be a label of suspicious where the subset is referred to as “suspicious predictions 2222.”

Referring to FIG. 22C, the third phase in the operational flow 2200 illustrates the generation of “golden labels” 2226 through an active learning procedure of the predictive results 2220 and subsequently utilizing the golden labels 2226 to retrain the pretrained LLM and the detection model. In more detail, the predictive results 2220 are analyzed through an active learning procedure 2224 that includes operations of (i) generating a prompt for a pretrained LLM 2214 that includes instructions to process a data entry and a corresponding predictive result and receiving corresponding confidence levels 2222; and (ii) providing a subset of the lowest confidence labels to a human (SME) user through a graphical user interface (GUI) 2225 with user feedback received corresponding to a human (SME) labeling as to whether each data entry is suspicious or benign. Additionally, the suspicious predictions 2222 may be provided directly to a human (SME, data owner, or owner of the network device that generated the corresponding data entry) via the GUI 2225. It should be understood that the GUI 2225 may refer to a plurality of GUIs. In other implementations, the suspicious predictions 2222 and/or the subset of lowest confidence predictive results may be provided in other forms for human review, e.g., email, text file, etc. Subsequently, a golden label generation logic 2224A that is associated with the active learning procedure 2224 then generates the golden labels 2226 from the user feedback on the lowest confidence predictive results and the suspicious predictions 2222. The golden labels 2226 refer to trusted and validated labels that are otherwise considered “ground truth.”

The operational flow 2200 continues with the golden labels 2226 being utilized in a re-training process of each of the pretrained LLM 2214 (retraining 2228) and the detection model 2218 (retraining 2230). The retraining 2230 of the detection model 2218 results in an “evolution” of the detection model 2218. Similarly, the retraining 2228 of the pretrained LLM 2214 results in an “evolution” of the LLM 2214.

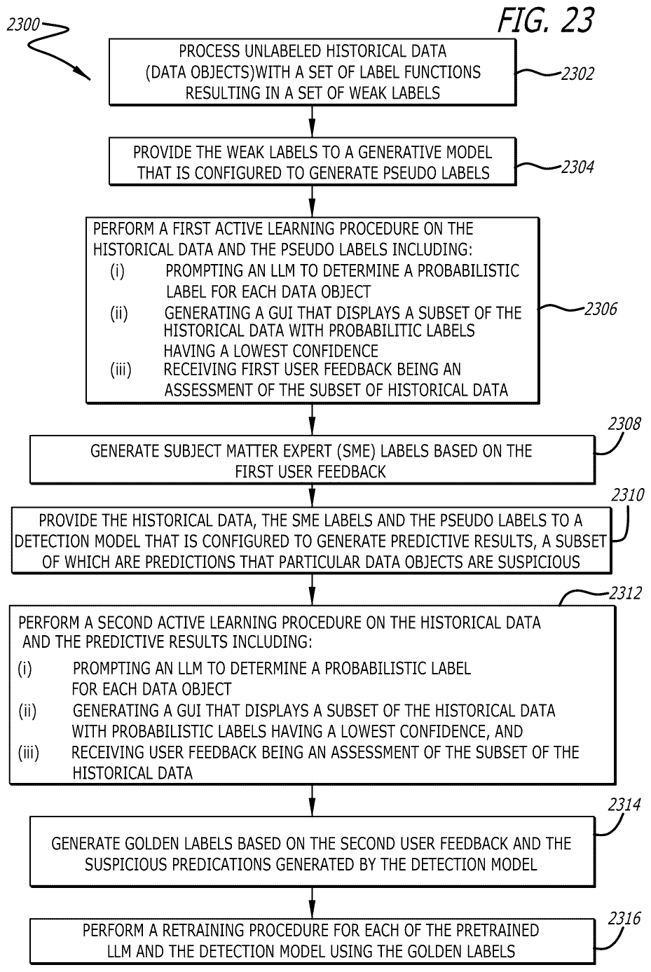

Referring now to FIG. 23, a flowchart illustrating example operations for performing a re-training of machine learning models by automatically generating labels for unlabeled, historical data through machine learning and active learning techniques is shown in accordance with various embodiments of the disclosure. Each block illustrated in FIG. 23 represents an operation in the process 2300 but it should be understood that not every operation illustrated in FIG. 23 is required. In fact, certain operations may be optional to complete aspects of the process 2300. The discussion of the operations of process 2300 may be done so with reference to any of the FIGURES described herein and particularly FIGS. 22A-22C.

Prior to the beginning of the process 2300, it is assumed that historical data 2002 has been generated by network devices and received by logic performing the process 2300. In some examples, the historical data comprises historical log data comprised of a plurality of data objects are a plurality of logs that represent recordings of activities or occurrences during operation of a network device. Each recording may include or involve a script or an executable file, such as a PowerShell script. In some examples, the recordings of the historical log data are Windows Events. In particular, such historical data 2002 is unlabeled with respect to whether each log entry (and generally discussed as a “data entry” in the disclosure) is suspicious or benign (or other classification such as malicious).

The process 2300 begins with an operation of processing the unlabeled historical data with a set of label functions resulting in a set of weak labels (block 2302). In some examples, the weak labels may be the weak labels 2206 of FIG. 22A, which may be a matrix of label function results. As noted above, label functions may be logic (or executable instructions) that, when executed, search a data entry such as a Windows Event for specific patterns and flag the presence of a pattern as suspicious. The weak labels are then provided to a generative model that is configured to generate a label such as suspicious or unknown (e.g., abstaining from a decision) for each data entry (block 2304). The labels generated by the generative model are generally referred to herein as “pseudo labels.”

A first active learning procedure is then performed on the pseudo labels including operations of generating a prompt instructing an LLM to determine a confidence level for the pseudo label of each data entry, transmitting the prompt and receiving a response, generating a GUI that displays a subset of the pseudo labels having a lowest confidence, and receiving first user feedback being an assessment of the subset of pseudo labels (block 2306). The subset of pseudo labels having a lowest confidence may be a predetermined number of pseudo such as 10, 50, 100, etc., a predetermined percentage of the pseudo labels such as 1%, 2%, 5%, etc., or any pseudo labels that has a confidence level below a threshold confidence level. The GUI may be viewed by a subject matter expert that provides human-in-the-loop labeling of the pseudo labels having the lowest confidence. Thus, by pulling out the pseudo labels having the lowest confidence as generated by a generative model and presenting only the small percentage of such low confidence pseudo labels for human-in-the-loop review, the systems and methods for generating golden labels (discussed below) is scalable. Subsequently, from the first user feedback, SME labels are generated (block 2308).

The SME labels and the pseudo labels are provided as input to a detection model that is configured to generate predictive results, a subset of which are predictions that particular data entries are suspicious (block 2310). In some examples, the detection model corresponds to the BA model 1112 discussed above.

A second active learning procedure is then performed on the predictive results including operations of generating a prompt instructing an LLM to determine a confidence level for the labels corresponding to the predictive results, transmitting the prompt and receiving a response, generating a GUI that displays a subset of the predictive results having a lowest confidence, and receiving second user feedback being an assessment of the subset of the predictive results, where the assessment is whether each data entry is suspicious or benign (block 2312). Additionally, third user feedback is obtained that is an assessment of the suspicious predictions, where the assessment is whether each data entry is suspicious or benign (block 2314). Subsequently, from the second and third user feedback, golden labels are generated (block 2316).

Finally, a retraining procedure is performed for each of the pretrained LLM and the detection model using the golden labels (block 2318). The retraining procedures correspond to an evolution of the pretrained LLM and the detection model, as shown in the operational flow 2200 of FIGS. 22A-22C. For instance, the retrained models replace prior versions in the operational flow 2200, and importantly, the retrained detection model may be deployed in a behavioral analytics platform that is configured to detect cyberthreats on data in real-time or near real-time.

Various examples and possible implementations have been described above, which recite certain features and/or functions. Although these examples and implementations have been described in language specific to structural features and/or functions, it is understood that the subject matter defined in the appended claims is not necessarily limited to the specific features or functions described above. Rather, the specific features and functions described above are disclosed as examples of implementing the claims, and other equivalent features and acts are intended to be within the scope of the claims. Further, any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Processing of the various components of systems illustrated herein can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Examples have been described with reference to flow chart illustrations and/or block diagrams of methods, apparatus (systems), and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A computer-implemented method, comprising:
obtaining historical data including a plurality of data objects;
performing, by a large language model (LLM), inferencing on the historical data resulting in generation of probabilistic labels including a probabilistic label for each of the plurality of data objects, wherein a first probabilistic label indicates whether a first data object is suspicious or benign;
determining a subset of the data objects with probabilistic labels having lowest confidence scores associated therewith;
generating a graphical user interface (GUI) that displays the subset of the data objects;
receiving user input indicating a label for each of the subset of the data objects; and
when a percentage of the probabilistic labels that deviates from labels comprising the user input meets or exceeds a threshold percentage, initiating a re-training process on the LLM.

2. The computer-implemented method of claim 1, wherein the historical data comprises historical log data, wherein the plurality of data objects are a plurality of logs that represent recordings of activities or occurrences during operation of a network device, and wherein each recording includes or involves a script or an executable file.

3. The computer-implemented method of claim 2, wherein the script or the executable of each recording of the historical log data is a PowerShell script.

4. The computer-implemented method of claim 2, wherein the recordings of the historical log data are Windows Events.

5. The computer-implemented method of claim 1, wherein the re-training process includes re-training or fine tuning the LLM on training data that includes data objects labeled by the LLM at a previous point in time.

6. The computer-implemented method of claim 1, wherein the user input indicating the label for each of the subset of the data objects represents labels generated by a subject matter expert indicating whether each of the subset of the data objects is suspicious or benign.

7. The computer-implemented method of claim 1, further comprising:
comparing the probabilistic labels to labels generated by a second machine learning (ML) model; and
initiating a second re-training process on the ML model when the labels generated by the second ML model deviate from the probabilistic labels generated by the LLM at least by a second threshold percentage.

8. A computing device, comprising:
a processor; and
a non-transitory computer-readable medium having stored thereon instructions that, when executed by the processor, cause the processor to perform operations including:
obtaining historical data including a plurality of data objects,
performing, by a large language model (LLM), inferencing on the historical data resulting in generation of probabilistic labels including a probabilistic label for each of the plurality of data objects, wherein a first probabilistic label indicates whether a first data object is suspicious or benign,
determining a subset of the data objects with probabilistic labels having lowest confidence scores associated therewith,
generating a graphical user interface (GUI) that displays the subset of the data objects,
receiving user input indicating a label for each of the subset of the data objects, and
when a percentage of the probabilistic labels that deviates from labels comprising the user input meets or exceeds a threshold percentage, initiating a re-training process on the LLM.

9. The computing device of claim 8, wherein the historical data comprises historical log data, wherein the plurality of data objects are a plurality of logs that represent recordings of activities or occurrences during operation of a network device, and wherein each recording includes or involves a script or an executable file.

10. The computing device of claim 9, wherein the script or the executable of each recording of the historical log data is a PowerShell script.

11. The computing device of claim 9, wherein the recordings of the historical log data are Windows Events.

12. The computing device of claim 8, wherein the re-training process includes re-training or fine tuning the LLM on training data that includes data objects labeled by the LLM at a previous point in time.

13. The computing device of claim 8, wherein the user input indicating the label for each of the subset of the data objects represents labels generated by a subject matter expert indicating whether each of the subset of the data objects is suspicious or benign.

14. The computing device of claim 8, wherein the operations further comprise:
comparing the probabilistic labels to labels generated by a second machine learning (ML) model; and
initiating a second re-training process on the ML model when the labels generated by the second ML model deviate from the probabilistic labels generated by the LLM at least by a second threshold percentage.

15. A non-transitory computer-readable medium having stored thereon instructions that, when executed by one or more processors, cause the one or more processor to perform operations including:
obtaining historical data including a plurality of data objects;
performing, by a large language model (LLM), inferencing on the historical data resulting in generation of probabilistic labels including a probabilistic label for each of the plurality of data objects, wherein a first probabilistic label indicates whether a first data object is suspicious or benign;
determining a subset of the data objects with probabilistic labels having lowest confidence scores associated therewith;
generating a graphical user interface (GUI) that displays the subset of the data objects;
receiving user input indicating a label for each of the subset of the data objects;
when a percentage of the probabilistic labels that deviates from labels comprising the user input meets or exceeds a threshold percentage, initiating a re-training process on the LLM.

16. The non-transitory computer-readable medium of claim 15, wherein the historical data comprises historical log data, wherein the plurality of data objects are a plurality of logs that represent recordings of activities or occurrences during operation of a network device, and wherein each recording includes or involves a script or an executable file.

17. The non-transitory computer-readable medium of claim 16, wherein the script or the executable of each recording of the historical log data is a PowerShell script, and wherein the recordings of the historical log data are Windows Events.

18. The non-transitory computer-readable medium of claim 15, wherein the re-training process includes re-training or fine tuning the LLM on training data that includes data objects labeled by the LLM at a previous point in time.

19. The non-transitory computer-readable medium of claim 15, wherein the user input indicating the label for each of the subset of the data objects represents labels generated by a subject matter expert indicating whether each of the subset of the data objects is suspicious or benign.

20. The non-transitory computer-readable medium of claim 15, wherein the operations further comprise:
comparing the probabilistic labels to labels generated by a second machine learning (ML) model; and
initiating a second re-training process on the ML model when the labels generated by the second ML model deviate from the probabilistic labels generated by the LLM at least by a second threshold percentage.
